(19) United States
(12) Patent Application Publication
(10) Pub. No.: US 2026/0320953 A1
(43) Pub. Date: Oct. 15, 2026

(54) SYSTEM AND METHOD FOR THREE-DIMENSIONAL (3D) BODY RECONSTRUCTION AND PERSONALIZED VIRTUAL GARMENT FITTING

(71) Applicant: Sizeologic, Inc., Houghton, MI (US)

(72) Inventors: Daniel John Bowen, Huntingburg, IN (US); Lauro José Lyrio, Vitória (BR); Nicholas Robert Blaauboer, Schenectady, NY (US); Michael Dykier, Rancho Cucamonga, CA (US); Brennan Charles Zuber, Tehachapi, CA (US); Jordan Ruth Craven, Whitmore Lake, MI (US)

(21) Appl. No.: 19/646,138

(22) Filed: Apr. 13, 2026

Related U.S. Application Data
(60) Provisional application No. 63/788,504, filed on Apr. 14, 2025.

(51) Int. Cl. G06T 19/20; G06T 7/11; G06T 7/194; G06T 7/246; G06T 7/50; G06T 7/60; G06T 7/73; G06T 17/20; G06V 20/64; G06V 40/10

(52) U.S. Cl. CPC G06T 19/20; G06T 7/11; G06T 7/194; G06T 7/246; G06T 7/50; G06T 7/60; G06T 7/74; G06T 17/20; G06V 20/64; G06V 40/10; G06T 2200/04; G06T 2207/10024; G06T 2207/10028; G06T 2207/30196; G06T 2210/56; G06T 2219/2004; G06T 2219/2016; G06T 2219/2021

(57) ABSTRACT

Systems and methods for generating a personalized 3D model of a human body using RGB and depth data captured by a depth-sensing mobile device. The system processes a sequence of image and depth frames to reconstruct a 3D mesh and automatically detects anatomical landmarks. A digital garment model is aligned to the mesh using attachment points defined on both the garment and the body. The system evaluates the proximity and conformity between garment attachment points and corresponding body landmarks to calculate a fit confidence score. Users may interactively select cross-sections of the mesh to view perimeter measurements and assess garment fit. Data is transmitted between a mobile application and a remote server via an API, enabling efficient processing and retrieval of reconstructed models and measurement data. The system supports personalized virtual fitting experiences, dynamic garment recommendations, and clothing size predictions, enhancing user satisfaction in e-commerce and apparel applications.

### CROSS-REFERENCE TO RELATED APPLICATIONS

This application claims the priority benefit of U.S. Provisional Patent Application Ser. No. 63/788,504, filed Apr. 14, 2025, the contents of which are herein incorporated by reference in their entirety.

### TECHNICAL FIELD

This disclosure relates generally to the field of computer vision (CV) and three-dimensional (3D) modeling, and more specifically, to the field of virtual body reconstruction and garment fitting using depth-sensing technology and machine learning techniques.

### BACKGROUND

The apparel industry has increasingly embraced digital technologies to enhance user experience, particularly through virtual fitting solutions aimed at improving sizing accuracy and reducing return rates. Traditional size charts and static models often fail to account for the diverse range of human body shapes and dimensions, leading to customer dissatisfaction and inefficiencies in online retail environments. Existing systems for virtual garment fitting typically rely on 2D images, manual measurements, or third-party body scanning equipment, which can be expensive, inaccessible, or difficult for users to operate independently.

Furthermore, current approaches to virtual try-on modalities often fail to account for anatomical alignment between the user’s body and the garment, such as where sleeves, waistbands, or shoulder seams should rest. These systems also lack methods for detecting body landmarks, accounting for garment positioning, and evaluating the quality of the fit with any level of confidence or accuracy.

### SUMMARY

There is a need for a system that enables users to generate accurate 3D representations of a human body using commonly available mobile devices, identify body landmarks automatically, and align virtual garments based on those features. In addition, there is a need for systems that can evaluate the attachment and fit of clothing models with respect to body landmarks and generate feedback, such as confidence scores, based on the predicted alignment. Such systems would allow for more accurate sizing, improved user satisfaction, and better-informed purchase decisions in virtual retail and fitness applications.

### BRIEF DESCRIPTION OF THE DRAWINGS

The foregoing is a summary, and thus, is necessarily limited in detail. The above- mentioned aspects, as well as other aspects, features, and advantages of the present technology are described below in connection with various embodiments, with reference made to the accompanying drawings.

FIG. 1 is a block diagram of an electronic device implementing a system that places a 3D model of a garment in an image of a 3D mesh of a human figure, based on rectified depth data and based on image segmentation, according to some embodiments of the present disclosure.

FIG. 2 is a block diagram illustrating an example of the system of the electronic device of FIG. 1 placing the 3D model of a garment over the foreground figure and the foreground figure distinguished from the background based on rectified depth data and based on image segmentation, according to some embodiments of the present disclosure.

FIG. 3 is a block diagram illustrating the electronic device of FIG. 1, according to some embodiments of the present disclosure.

FIG. 4 is a block diagram illustrating a system, according to some embodiments of the present disclosure.

FIG. 5 is a flowchart illustrating a method, according to some embodiments of the present disclosure.

FIG. 6 is a flowchart further illustrating the method from FIG. 5, according to some embodiments of the present disclosure.

FIG. 7 is a flow diagram illustrating a method implemented by the system of FIG. 1 for 3D body mesh reconstruction and virtual garment alignment, according to some embodiments of the present disclosure.

FIG. 8 illustrates a side-by-side view of a depth image and a red, green, and blue (RGB) image of a human subject with arms extended, as captured by a depth-sensing camera of the electronic device of FIG. 1 and implementing a portion of the method of FIG. 7, according to some embodiments of the present disclosure.

FIG. 9 illustrates an example of semantic segmentation applied to RGB and depth image data of FIG. 8, where a CV model generates a binary mask for isolating a human figure, according to some embodiments of the present disclosure.

FIG. 10 illustrates a 3D point cloud representation of a human subject generated from aligned RGB and depth image data of FIG. 9 using intrinsic calibration parameters, according to some embodiments of the present disclosure.

FIG. 11 illustrates a unified 3D mesh model of a human subject generated by registering multiple point clouds of the 3D point cloud representation of a human subject of FIG. 10 obtained from sequential camera frames, using one or more spatial alignment techniques according to some embodiments of the present disclosure.

FIG. 12 illustrates a 3D mesh of a human subject generated from the integrated point cloud of FIG. 11 using a Truncated Signed Distance Function (TSDF) volume, according to some embodiments of the present disclosure.

FIG. 13 illustrates an interactive user interface for body measurement extraction from the 3D mesh of FIG. 12, showing a cross-sectional slicing plane positioned across the torso of a reconstructed human mesh, according to some embodiments of the present disclosure.

### DETAILED DESCRIPTION

The foregoing is a summary, and thus, is necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the claimed subject matter. Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

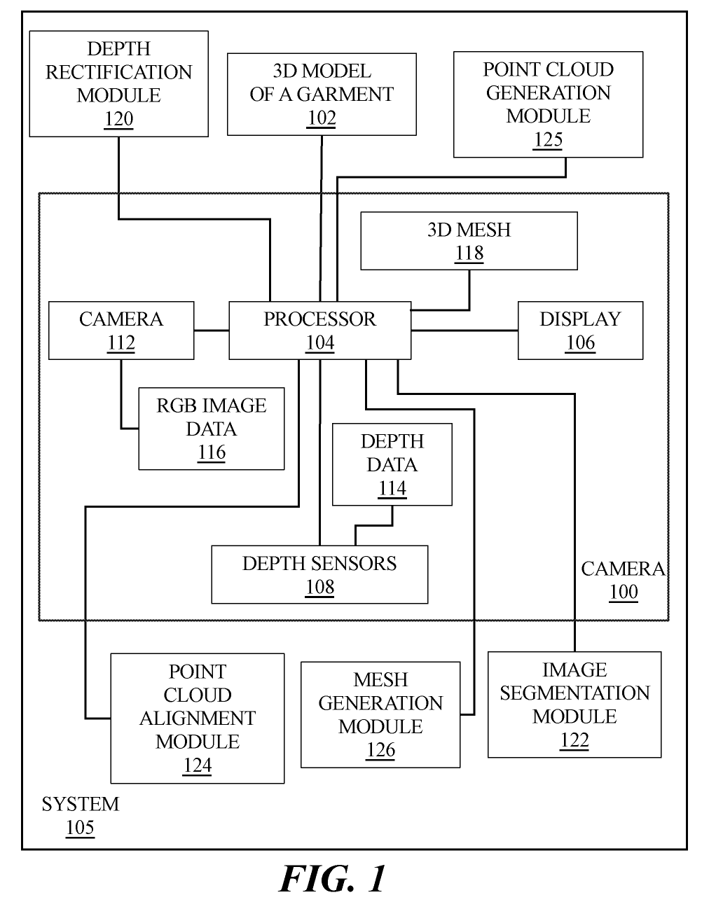

FIGS. 1-13 illustrate example systems and methods for 3D body reconstruction and personalized virtual garment fitting. The system may generate a highly personalized virtual fitting experience by combining any combination of 3D body scanning, body landmark detection, clothing model integration, and fit confidence scoring. In a non-limiting example, the system may carry out such a virtual fitting experience by extracting a full-body mesh of a scanned body image, for example, captured using a depth-enabled mobile device. The system may process the full-body mesh to derive a series of anatomical measurements. These measurements may be obtained either immediately after reconstruction of the body image or in parallel with mesh generation using cross-sectional slicing and volumetric analysis. Concurrently, the system performs body landmark detection to identify one or more anatomical reference points used for clothing alignment. These landmarks may include, but are not limited to, one or both: shoulders, clavicles, hips, and/or a waist, a chest centerline, an upper back, and a thigh midline, among others. The specific set of landmarks detected can vary based on the category of clothing being modeled. For example, the landmark set for a tailored jacket may differ from that of athletic leggings or a loose-fitting dress.

Each clothing type within the system’s digital catalog includes a predefined set of attachment points, representing the expected resting positions of the garment on the human body. These attachment points may be defined in relation to both the clothing model geometry and the anatomical landmarks detected on a three-dimensional (3D) mesh representing a body (or body portion) of the user. During a virtual try-on or fitting simulation, the clothing model may be computationally aligned to the user’s mesh by matching these attachment points with the corresponding body landmarks. This alignment process accounts for body shape variability and may be adapted using deformation models or draping simulations. Once the attachment process is complete, the system may calculate the distance and surface conformity between the garment’s attachment points and the corresponding areas on the user’s body. These distances are used to assess a confidence level of the predicted fit (e.g., a fit confidence). For example, a higher confidence score may be generated when garment attachment points align closely with the body’s landmark geometry, indicating a good match. Fit confidence may also incorporate garment behavior, such as tightness or looseness, at specific body zones. For example, the fit at the waistline may be prioritized in tight-fitting garments, while looser garments may allow greater variance in shoulder or hip alignment.

The digital catalog may support one or more workflows for generating and storing the garment models and their associated attachment point definitions. In some embodiments, the system may ingest pre-generated or predefined 3D garment models generated using external design software, apparel simulation platforms, or brand-provided digital assets. For example, garment models may be generated in computer-aided design or garment simulation environments such as fashion design software, textile simulation tools, or brand-specific digital asset pipelines and then exported as mesh files including, but not limited to, formats such as OBJ, FBX, GLTF, or PLY. When such externally generated models are imported into the catalog, the system may analyze the garment geometry and any associated metadata to identify or generate corresponding attachment points compatible with the anatomical landmark framework of the system. In some embodiments, the imported garment model may include one or more predefined anchor locations, seam references, and/or rigging points defined by the originating software platform. For example, a jacket model may include anchor points corresponding to shoulder seams, sleeve cuffs, and/or a collar edge, while a pair of pants may include anchor points corresponding to a waistband, hip seams, and/or inseam junctions. The system may map these anchor locations to standardized attachment points within the catalog so that the garment can be consistently aligned with body landmarks during a virtual fitting process.

In other embodiments, the system may generate garment models internally within the catalog environment. In this workflow, a 3D garment representation may be created or modified within the system using one or more garment pattern definitions, parametric garment templates, and/or mesh editing tools. For example, a template for a short-sleeve shirt may be generated from predefined pattern pieces representing a front panel, back panel, and sleeves, which are then assembled into a 3D mesh. During this generation process, attachment points may be defined relative to structural features of the garment geometry. Such features may include, but are not limited to, a neckline region, a shoulder seam, a sleeve attachment region, a waistline contour, a hemline boundary, a pocket region, and/or a zipper edge. In some implementations, attachment points may be automatically generated based on detected seam intersections or curvature features of the mesh. In other implementations, attachment points may be manually placed by a user, such as a designer, for example, through a graphical interface to correspond with anatomical landmarks such as a shoulder, a hip, a knee, an elbow, and/or a waist region of a body mesh of a user. By supporting both ingestion of externally created garment models and internal generation of garment models with defined attachment points, the catalog architecture allows clothing assets from one or more brands, design tools, or modeling pipelines to be normalized into a consistent attachment-point framework. This approach ensures that garments originating from different sources can be accurately aligned with user body meshes and evaluated during virtual fitting simulations.

The described catalog architecture provides technical improvements in the operation of computer-based 3D modeling and rendering systems used for virtual garment fitting. In particular, the system introduces a structured attachment-point framework that enables a computing device to reliably align heterogeneous 3D garment meshes with reconstructed 3D body meshes using predefined geometric anchor relationships. By normalizing attachment point definitions across garment models originating from different software environments or design pipelines, the system improves interoperability between disparate digital garment assets and enables automated garment-to-body alignment without requiring manual adjustment or ad hoc mesh manipulation. This structured mapping between garment attachment points and anatomical body landmarks allows the computing system to perform deterministic alignment operations that improve the stability and accuracy of garment positioning relative to the reconstructed body mesh.

The use of standardized attachment-point mappings further reduces the computational complexity associated with dynamically determining garment-body correspondence during runtime rendering operations. Rather than repeatedly performing computationally expensive geometric searches across garment meshes and body meshes, the system leverages predefined attachment nodes or points that directly correspond to anatomical landmarks detected on the body mesh associated with the user. This improves processing efficiency on resource-constrained devices such as mobile phones and reduces the processing load for garment-body registration during interactive virtual fitting simulations.

Additionally, the attachment-point framework improves the functioning of the underlying computer graphics and simulation pipeline by enabling more stable deformation modeling, collision detection, and physics-based fabric simulation. Because the garment mesh is anchored to known anatomical reference points, deformation models can propagate garment adjustments relative to consistent spatial reference points on the body mesh. This results in improved stability when the user changes pose, improved detection of garment-body intersections, and more accurate simulation of fabric behavior. These improvements provide a technical solution to the problem of inconsistent garment alignment and unstable garment simulation that commonly occurs when digital garments generated by different software systems are integrated into a unified virtual fitting environment.

Furthermore, the system improves the ability of a computing device to ingest and process externally generated 3D garment assets while maintaining a consistent internal representation suitable for automated simulation and rendering. By transforming heterogeneous garment assets into a normalized attachment-point structure, the system enables reliable computational processing of garment meshes originating from one or more external design tools without requiring manual mesh restructuring or reconstruction. This improves the scalability and efficiency of digital garment processing systems and enhances the technical operation of virtual garment fitting platforms implemented on distributed computing architectures, including mobile devices and remote servers. Thus, these improvements represent technical solutions to challenges associated with 3D mesh alignment, garment simulation stability, and/or computational efficiency in computer graphics systems. The system therefore improves the functioning of computer-based virtual fitting platforms by introducing one or more data structures, alignment mechanisms, and/or processing techniques that facilitate reliable garment-body correspondence and/or efficient real-time simulation using sensor-derived body meshes.

The system supports garment-specific fit scoring by associating historical return rates, satisfaction scores, and known fitting issues with particular styles or brands. Some performance indicators (KPIs) related to garment dissatisfaction can be analyzed across body types, garment categories, and demographics such as age, gender, and location. This analysis supports both personalized recommendations and brand-specific feedback. In some embodiments, machine learning models may be applied to refine landmark detection, pattern recognition in scan-to-fit relationships, and/or predictive modeling of fit satisfaction. Over time, the system may identify trends across user cohorts, for example, consistent misalignment in shoulder seams for users with broader frames, allowing for intelligent garment recommendations or sizing adjustments.

Each digital garment may also be associated with metadata describing fit characteristics (e.g., slim fit, relaxed, athletic cut, etc.) and material behavior (e.g., stretch, drape, etc.), which further informs the attachment and confidence scoring processes. Structured data pipelines manage this metadata alongside mesh and measurement outputs, ensuring consistency across users and garments. Some embodiments of the system may incorporate demographic prediction, digital twin generation, and integration with third-party platforms such as retailer APIs or body-modeling services. Discussions with external partners (e.g., athletic apparel brands or academic groups) may inform training sets and expand use cases. The system may also evolve into a platform with in-house machine learning capabilities as a core competency, with 3D modeling and reconstruction serving as a core component that supports end-to-end digital fit workflows.

In some conventional virtual garment fitting and body measurement systems, many technical challenges persist. These include the inability to extract accurate body measurements using 2D image data alone, difficulty in generating full-body 3D meshes from consumer-grade sensors, and inefficient alignment of garment models with human body representations. Additionally, such systems often lack the ability to dynamically adapt to user posture changes, resulting in unrealistic fitting simulations, particularly in mobile or resource-constrained environments. A technical solution to these problems is implemented through a mobile-enabled system and method that leverages synchronized RGB and depth sensing, real-time segmentation, 3D reconstruction, and mesh alignment to generate accurate representations of the human body. In some embodiments, the system captures at least one RGB image and depth data corresponding to a portion of the human body. A processor segments the RGB image into foreground and background pixels using the depth data to isolate the body. The foreground pixels and mapped depth values are transformed into three-dimensional point clouds using intrinsic parameters of the image sensor. These point clouds are then aggregated and aligned to generate a 3D mesh of the human body, which serves as a geometric foundation for further analysis and garment fitting.

As used herein, the term “RGB” refers to a digital color representation format in which image data is represented using three color channels corresponding to red, green, and blue light components. In an RGB image, each pixel includes a set of values representing intensity levels of the red channel, the green channel, and the blue channel detected at that pixel location by an image sensor. These three color channel values collectively define the color of the pixel and allow a computing system to represent and process visual information captured from a scene. RGB image data may be captured by an image sensor of an electronic device, such as a camera integrated within a mobile device, tablet, wearable device, and/or other computing system capable of capturing digital images.

In some embodiments, the RGB image may be stored as a multi-channel image in which each pixel location corresponds to a triplet of values representing the red, green, and blue intensities detected by the sensor. For example, a pixel may be represented by a numerical triplet corresponding to red intensity, green intensity, and blue intensity, which together describe the color and brightness of the observed portion of the scene. Within the systems and methods described herein, RGB images may provide visual information representing a captured scene, including a human body and/or surrounding objects within the field of view of the image sensor. The RGB image data may be processed by one or more computer vision algorithms to identify edges, textures, object boundaries, and/or feature points associated with the captured subject. In some embodiments, RGB image data may be used in combination with depth data captured from one or more depth sensors to generate point clouds, perform segmentation of foreground and background pixels, estimate pose information, and/or support reconstruction of a three-dimensional representation of the captured subject.

Pose estimation algorithms may be implemented to detect skeletal positions across frames captured at different time intervals, thereby allowing the system to stabilize the 3D mesh over time. A binary mask may be generated by identifying the outer perimeter edge of the human body within the segmented image, enabling perimeter-based measurement extraction and visual occlusion for compositing digital garments. Point cloud registration is further refined using iterative closest point (ICP) alignment and visual feature extraction, such as Scale-Invariant Feature Transform (SIFT), to estimate scale and rotation changes between multiple point clouds. This hybrid approach ensures accurate and consistent reconstruction across multiple views. The system may also include landmark detection on the 3D body mesh, allowing for precise correspondence between anatomical points and predefined garment attachment nodes. A 3D model of a garment is aligned with the mesh using these body landmarks and dynamically deformed based on skeletal pose data, point cloud geometry, and physics-based fabric simulations. This enables realistic visualization of garment fit and behavior, particularly when the user changes posture or position.

In some embodiments, the system is implemented on a mobile device in communication with a remote server, enabling efficient offloading of processing tasks and data transmission via an application programming interface (API). This distributed architecture allows for high-quality 3D reconstruction and measurement extraction in real time, without requiring dedicated scanning hardware. Collectively, the described techniques address longstanding technical limitations in 3D body modeling, virtual fitting, and mobile visualization by providing a practical, sensor-based system architecture and an image-to-mesh processing pipeline.

FIG. 1 is a block diagram of an electronic device 100 to place a 3D model of a garment 102 onto a 3D mesh 118 of a human figure based on depth data 114 and RGB image data 116, according to some embodiments of the present disclosure. As used herein, and as noted above, the term “RGB” refers to a color imaging format in which image data is represented using three color channels: Red, Green, and Blue. Each pixel in an RGB image includes a combination of red, green, and blue intensity values, which are combined to produce a full-color representation of a scene. RGB image data 116 may be captured by an image sensor, such as a camera integrated into a mobile or electronic device, and may be stored, processed, or analyzed to extract visual features, identify objects, or generate color textures. In some embodiments, RGB data may be used in conjunction with depth data to perform operations such as segmentation, point cloud generation, and visual alignment in three-dimensional modeling systems. As used herein, the term "garment" refers to any article or item of clothing that is intended to be worn on a human body or a portion thereof. A garment may include, but is not limited to, shirts, pants, dresses, skirts, jackets, coats, undergarments, footwear, hats, gloves, or accessories such as scarves, glasses, sunglasses, jewelry, watches, and/or belts. In some embodiments, a garment may be represented as a 3D digital model for simulation, visualization, fitting, rendering, and/or interaction within a virtual and/or augmented reality environment. The 3D model of a garment may include mesh geometry, texture mapping, and/or associated metadata describing physical properties such as material type, elasticity, drape, and/or size.

The electronic device 100 includes one or more depth sensors 108 and an RGB camera 112 (e.g., image sensor) for capturing depth data 114 and RGB image data 116, respectively, of at least one portion of a human body (not shown). These inputs are fed into a system 105 that has a depth rectification module 120 at a processor 104, which processes the depth data 114 to generate rectified, calibrated depth information aligned with the RGB image plane. The image segmentation module 122, of the system 105, uses the rectified depth data and the RGB image to segment the image into foreground and background pixels, identifying the region corresponding to the human body. The segmented image data is passed to a point cloud generation module 125, which constructs one or more point clouds representing the surface geometry of the human FIGURE(or portion of the human figure).

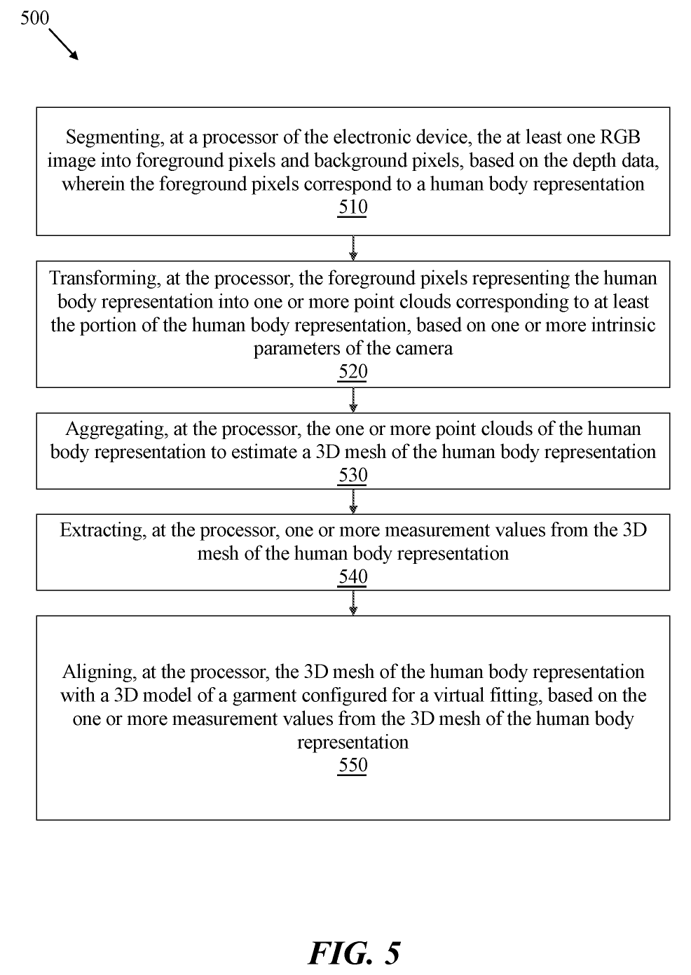

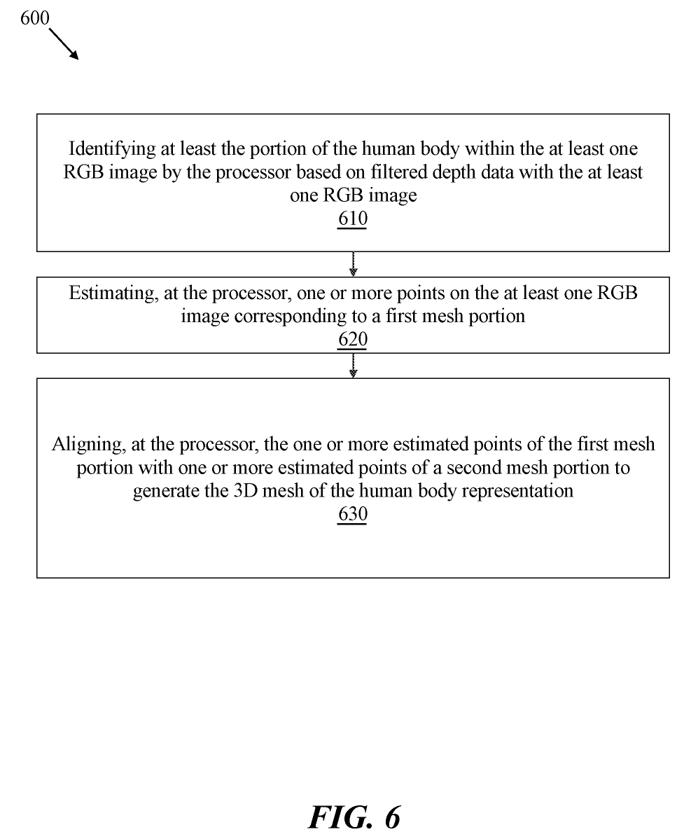

The image segmentation module 122, as part of the image processing and mesh generation pipeline of the system 105, accurately isolates anatomical regions, with particular success in segmenting the frontal torso. The segmentation output feeds into a point cloud generation and mesh construction pipeline, as further illustrated in FIG. 5 at block 510 through block 530. To enhance usability for a broader range of body types, the system may be optimized to operate at a distance of approximately 2.5 feet (about 0.76 meters) between the user and the device. This increased range, which is particularly beneficial for scanning larger individuals, ensures full-body capture during one or more user-initiated rotation scans. As described in FIG. 5, the subject rotates in place while the device remains stationary, enabling single-user operation without external assistance or environmental constraints. Once segmentation and mesh generation are complete, the processor 104 executes cross-sectional analysis by intersecting the mesh with horizontal planes and calculating perimeter values at one or more user-selected anatomical levels (e.g., waist, hips, and/or chest). These steps are referenced in FIG. 5 at block 540 and FIG. 6, where the mesh is refined, and one or more body measurement slices are identified.

The point cloud alignment module 124 may refine the spatial alignment of multiple point clouds, for example, using ICP registration. This process may include an initial transformation estimate to approximately align the source point cloud with the target point cloud, based on sensor pose information or feature-based heuristics. Once an initial alignment is set, the module may identify correspondences by finding, for each point in the source point cloud, the closest point in the target point cloud, typically using a nearest neighbor search algorithm such as a k-d tree. In some embodiments, the module may filter out outlier correspondences by rejecting pairs that exceed a distance threshold or applying statistical outlier removal techniques.

After determining valid correspondences, the module computes the optimal rigid transformation, including, but not limited to, rotation and translation, that minimizes the mean squared error between the matched point pairs. This transformation may be calculated using singular value decomposition (SVD) of the cross-covariance matrix between the source and target point sets. The resulting transformation is then applied to the source point cloud to update the alignment. The module checks for convergence based on predefined criteria, such as minimal change in alignment error or transformation parameters between iterations. If convergence is not yet achieved, the process repeats until the alignment error stabilizes or a maximum number of iterations is reached. Once the process converges, the point cloud alignment module 124 outputs the aligned source point cloud along with the final transformation matrix. This refined alignment facilitates the aggregation of multiple partial scans into a complete and coherent 3D representation, such as a human body mesh used for virtual garment fitting.

In some embodiments, the aligned point clouds are then passed to a mesh generation module 126, which estimates a 3D mesh 118 of the human body from the aggregated and aligned point cloud data. For example, to generate the 3D mesh, the module may integrate the multiple aligned point clouds into a unified volumetric representation. This may be accomplished using techniques such as a Truncated Signed Distance Function (TSDF), which accumulates surface information from different viewpoints to form a consistent volumetric field. The module may extract a surface mesh from this volumetric data using surface reconstruction algorithms, such as the marching cubes algorithm, to generate a watertight triangle mesh that approximates the outer surface of the body. In some implementations, additional refinement steps may be applied, such as smoothing, hole-filling, and/or removal of disconnected components using connected triangle clustering, to improve mesh quality and realism. The resulting 3D mesh provides a detailed geometric representation of the user’s body, which may then be used for measurement extraction, garment alignment, and/or realistic simulation of virtual fittings.

One or more body measurement extraction modules extract anthropometric measurements from the 3D mesh, such as circumferences or lengths at predefined cross-sections or landmarks. These measurements are used by a garment alignment and simulation module to align a 3D model of a garment with the 3D mesh of the body. In some embodiments, this module may apply physics-based simulation techniques to adjust garment fit and surface behavior in a manner that reflects realistic fabric dynamics. The aligned and simulated garment model is rendered via a display module 106, which outputs a composite view of the virtual garment overlaid on the body mesh. This view may be rendered as part of a virtual fitting experience, providing real-time or static visual feedback to the user.

As used herein, the term “electronic device” such as electronic device 100 implementing system 105, refers to any portable or non-portable computing system that includes at least one processor, memory, and input/output components to perform digital processing operations. An electronic device may include, but is not limited to, a smartphone, tablet computer, laptop computer, desktop computer, wearable device, smartwatch, head-mounted display (HMD), game console, or camera-equipped mobile device.

In some embodiments, an electronic device may include one or more sensors, such as cameras, depth sensors, inertial measurement units (IMUs), proximity sensors, or microphones, and may be capable of capturing, processing, transmitting, and displaying image, audio, video, and/or spatial data. The electronic device may operate as a standalone system or may be networked to other devices via wired or wireless communication protocols, such as Wi-Fi, Bluetooth, cellular, or near-field communication (NFC).

The electronic device may execute software applications stored in memory and operated by one or more onboard processors, including applications for image capture, 3D reconstruction, AR rendering, and user interaction. In certain embodiments, the electronic device may include specialized hardware, such as a TrueDepth camera, LiDAR sensor, or graphics processing unit (GPU), to support computationally intensive tasks such as point cloud generation, surface reconstruction, or virtual garment simulation.

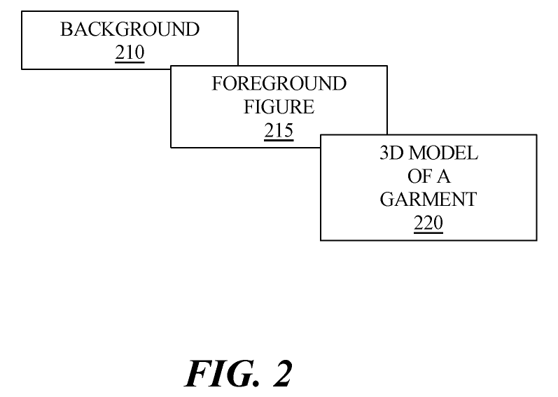

FIG. 2 illustrates an example of a system output in which a 3D model of a garment 220 is rendered in alignment with a foreground FIG. 215 that represents a segmented human body within a scene, according to some embodiments of the present disclosure. FIG. 2 includes three components: the background scene 210, the foreground FIG. 215, and the 3D model of a garment 220. The background scene 210 includes background data that represents the original environment captured by the RGB camera, which may include walls, furniture, or other visual elements not associated with the subject. The background data is identified and separated during the segmentation process, which may involve depth-based filtering and/or machine learning-based pixel classification to isolate the human figure.

The foreground FIG. 215 corresponds to the segmented human body, which has been extracted from the background using a combination of RGB and depth data. In some embodiments, this segmentation is performed using a body-part segmentation model and/or a similar neural network architecture. The segmented foreground serves as the anchor for generating a point cloud or 3D mesh representation of the subject’s body. This body model may be derived from multiple depth frames and refined through point cloud registration techniques such as ICP.

The 3D model of a garment 220 is overlaid onto the foreground FIG. 215. This garment model may be a digital representation of clothing stored as a mesh object with texture, material, and fit parameters. In some embodiments, the garment model is aligned to the 3D mesh of the body using pose estimation and body measurements extracted from the user’s mesh data. Alignment techniques may include mesh-to-mesh registration, skeletal landmark matching, or deformation models that adjust the garment geometry to conform to the surface of the body model.

The combined rendering of the foreground FIG. 215 and the 3D model of a garment 220 results in a composite visualization that simulates a virtual fitting experience. In this example, the garment may appear to be naturally worn by the figure, with proper orientation and alignment to match the user’s body geometry and posture. This visualization may be presented to the user through a mobile device or web interface, enabling real-time previewing, adjustment, and/or garment selection. This embodiment of the system enables personalized virtual try-on functionality by combining advanced segmentation, 3D reconstruction, and/or garment simulation in a unified visualization layer.

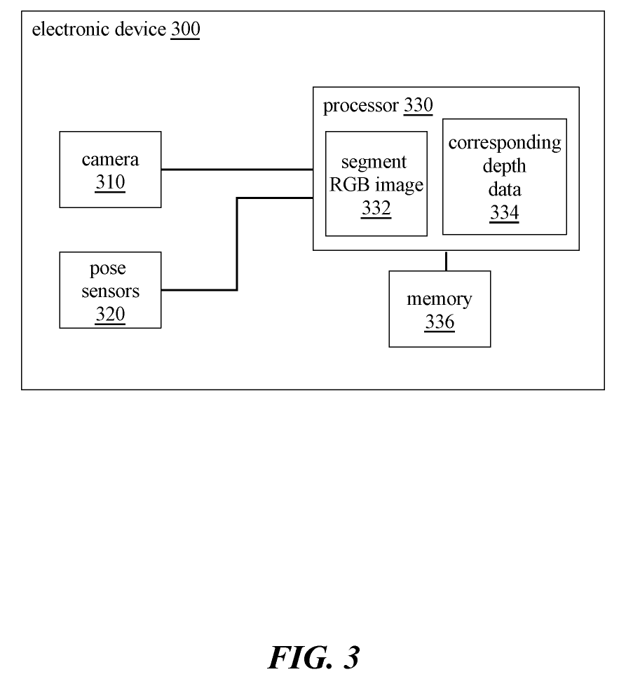

FIG. 3 illustrates an electronic device 300 to generate a virtual fitting experience, according to some embodiments of the present disclosure. The electronic device 300 may include a camera 310 to capture one or more RGB images of at least one portion of a human body and one or more pose sensors 320 to capture depth data indicating the estimated distance between the camera and the human body. A processor 330 is communicatively coupled to the camera 310 and the one or more pose sensors 320 and is further connected to a memory 336. In some embodiments, the processor 330 may segment 332 an RGB image captured by the camera 310 into foreground pixels and background pixels, based on the corresponding depth data 334. The foreground pixels correspond to an outer perimeter outline of the human body.

The processor 330 may also identify one or more anatomical landmarks or skeletal points from the captured data. In some embodiments, the memory 336 may store computer-readable instructions that, when executed by the processor 330, cause the processor to estimate a first skeletal pose from the first image and depth data captured during a first time period, and a second skeletal pose from a second image and corresponding depth data captured during a second time period. The processor may aggregate a point cloud from the first and second images and use the resulting data to generate a 3D mesh of at least a portion of the human body. The processor may further identify one or more skeletal points on the mesh and align a 3D model of a garment to the mesh based on the landmarks. In some embodiments, the processor renders the virtual fitting of the garment onto the 3D mesh using a display of the electronic device 300.

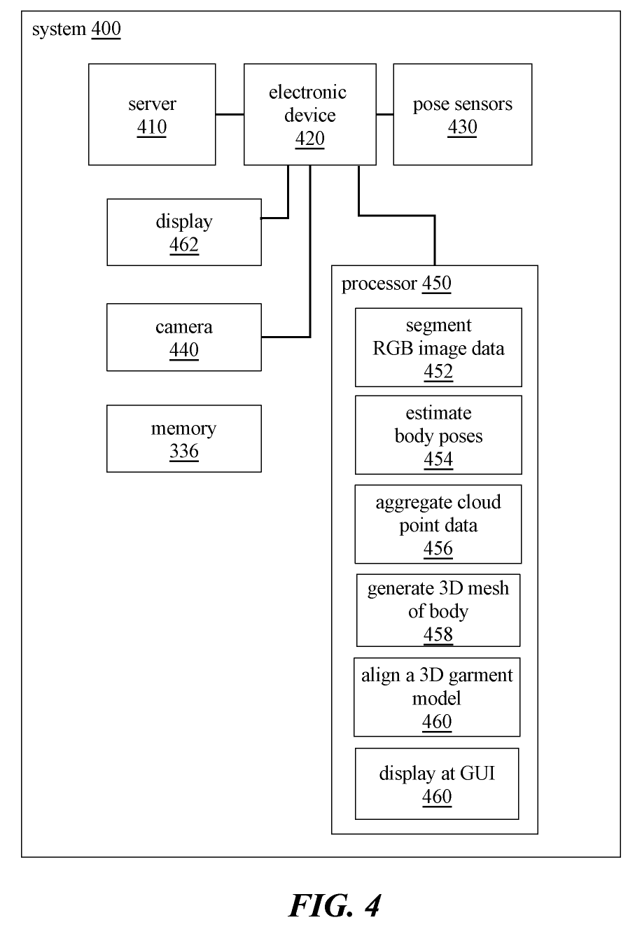

In another embodiment, and with reference to FIG. 3 and FIG. 4, the system includes a mobile-based 3D body scanning and measurement platform that may improve segmentation accuracy, increase scanning range, and support consistent data labeling across scan sessions. The system comprises an electronic device equipped with a depth-sensing camera (e.g., TrueDepth camera) and one or more processors for executing body-part segmentation, mesh generation, and measurement extraction.

As illustrated in FIG. 3, the electronic device 300 may include a camera 310 and one or more pose sensors 320 to capture synchronized RGB and depth data from a subject. A processor 330 and memory may perform segmentation and control user interface components. The system utilizes an open-source machine learning model, such as BodyPix, to perform person and body-part segmentation based on the incoming image and depth data. In some embodiments, segmentation occurs locally on the device, while in others it may be offloaded to a backend server.

FIG. 4 illustrates a system 400 for remote or distributed processing, according to some embodiments. The system 400 may include a server 410, an electronic device 420 communicatively coupled to the server 410, a camera 440 that may capture one or more RGB images of a human body, and one or more pose sensors 430 that may receive depth data indicating the estimated distance of the human body from the camera 440. The system also includes a processor 450 and a memory. The processor 450 may segment 452 RGB image data, estimate body poses 454, and aggregate 456 data to generate 458 a 3D mesh of the body. The processor 450 may align 460 a 3D garment model to the 3D mesh of the body using corresponding points and transmit mesh data, pose information, and/or point cloud data to the server 410 for display 462 at a graphical user interface (GUI) of the electronic device, for additional processing, analysis, and/or storage.

The server-side system, depicted in FIG. 4 as part of system 400, includes an API endpoint that receives depth and RGB data from the mobile application, performs vision-based ICP registration, and returns a reconstructed 3D mesh to the mobile device for user interaction. The server supports Map ID metadata for data tracking and scan-to-record association. Together, these system features provide a framework for collecting and analyzing 3D scan data with improved segmentation fidelity, measurement accuracy, and traceability. Continued development will focus on achieving sub-0.25 inch measurement precision by refining segmentation algorithms and validating against real-world datasets collected through user testing.

FIG. 5 illustrates a flowchart describing a method 500 for generating a virtual garment fitting, according to some embodiments. At block 510, the method 500 includes segmenting, at the processor (e.g., processor 104, processor 330, etc.), at least one RGB image into foreground and background pixels based on depth data. The foreground pixels correspond to a representation of the human body. For example, the RGB image and corresponding depth map captured by a mobile phone camera are processed to isolate the person standing in front of a wall, for example. Using the depth thresholding method, background elements (e.g., furniture, wall) are filtered out, and only the pixels associated with the person are retained as the foreground.

At block 520, the method 500 includes transforming the foreground pixels into one or more point clouds representing at least a portion of the human body, based on intrinsic parameters of the camera, such as focal length, principal point, and distortion coefficients. At block 530, the processor aggregates the point clouds to estimate a 3D mesh of the body. In some embodiments, this aggregation may include applying a connected triangle clustering algorithm to remove disconnected components. A TSDF may also be used to create a volumetric representation of the mesh. At block 540, the method 500 includes extracting one or more body measurements from the 3D mesh. In some embodiments, the processor may generate a binary mask by identifying the outer perimeter outline and/or edge of the body and compute horizontal slices through the mesh to derive measurements such as waist or chest circumference.

At block 550, the method 500 includes aligning the 3D mesh of the human body with a 3D model of a garment for virtual fitting. In some embodiments, the alignment includes performing an ICP function to register the garment model to the mesh by minimizing distances between corresponding regions. The processor may also identify vectors between point clouds using a scale-invariant feature transform (SIFT) to estimate scale and rotation adjustments prior to alignment. Once aligned, the processor may detect collisions or intersections between the garment model and the body mesh and adjust the fit accordingly.

In some embodiments, the processor may also apply a physics-based simulation using one or more fabric properties, such as stiffness, stretchability, and drape characteristics, to the 3D model of the garment. The garment is then disposed or overlaid onto the 3D mesh of the human body in a realistic manner, wherein a realistic manner includes, but is not limited to, digitally positioning the garment on the 3D mesh to simulate how the garment would fit based on the actual body measurements and/or to emulate the natural movement, flow, and/or settling behavior of fabric as it would occur on a physical body.

FIG. 6 illustrates a continuation of the method 500 described in FIG. 5, according to some embodiments. At block 610, the method 600 may include having the processor (e.g., processor 104, processor 330, etc.) identify at least a portion of the human body in the RGB image using filtered depth data. At block 602, the processor estimates one or more image points corresponding to a first mesh portion. At block 603 the processor 104 aligns these estimated points of the first mesh portion with points of a second mesh portion to refine or complete the 3D mesh of the human body.

In some embodiments, the processor 104 may dynamically adjust the virtual garment model in response to changes in the user’s pose or body movement, as detected in real time using updated depth data and skeletal tracking algorithms. The alignment of the garment may be continually refined using motion vectors associated with key skeletal landmarks. Additionally, garment recommendations may be rendered based on geographic location, demographic attributes such as age, gender, or race, or historical fitting data.

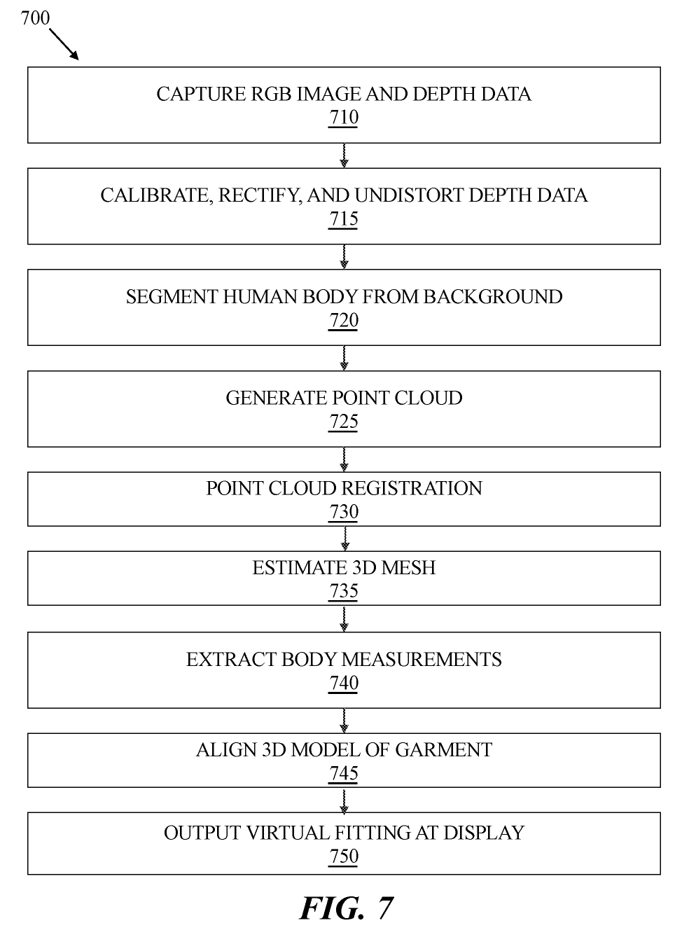

FIG. 7 is a flow diagram illustrating a method 700 for 3D body mesh reconstruction and virtual garment alignment, according to some embodiments of the present disclosure. At block 710, the method 700 may include having an electronic device 300 (or processor 104, processor 330, etc.) capture RGB image and depth data with a camera and one or more sensors. For example, the electronic device may be a mobile device or imaging system that collects both RGB and depth information from a human subject. This data may serve as the foundation for subsequent image processing and 3D modeling steps.

In some embodiments, the electronic device includes one or more depth sensors that may capture depth data representing the spatial distance between surfaces in a physical environment and the sensor itself. These depth sensors may include, but are not limited to, structured light sensors, time-of-flight (ToF) sensors, stereo vision systems, active infrared (IR) projection systems, and light detection and ranging (LiDAR) sensors. A structured light sensor operates by projecting a known light pattern onto a surface and analyzing the distortion of that pattern using an image sensor to determine surface depth. ToF sensors emit modulated light pulses and measure the time or phase delay between emission and reflection to compute depth information. Stereo vision systems capture images from two or more cameras positioned at known distances apart and compute disparity between corresponding image points to generate a depth map. Active IR systems use projected IR patterns or coded light to infer depth based on pattern deformation. In some embodiments, the electronic device may include LiDAR sensors, which emit laser pulses and measure the time it takes for the pulses to reflect off surfaces and return to the sensor, thereby producing high-resolution depth data across a wide field of view. These sensors may be embedded in mobile computing devices such as smartphones, tablets, AR headsets, or wearable scanning electronic devices. The captured depth frames may be synchronized with corresponding RGB image data to generate 3D representations of the human body for applications including mesh reconstruction, measurement extraction, landmark detection, and virtual garment alignment.

At block 715, the images from the camera are calibrated, rectified, and undistorted using one or more intrinsic parameters, such as focal length, principal point coordinates, and skew coefficients, in combination with lens distortion lookup tables that compensate for radial and tangential distortion introduced by the camera optics. These parameters are typically obtained through a camera calibration process specific to the depth-sensing device. The depth data is then aligned with the RGB image using these intrinsic calibration parameters, ensuring that each depth pixel is spatially registered with the corresponding RGB pixel. This pixel-to-pixel correspondence is essential for accurate 3D point cloud generation, surface reconstruction, and further processing stages such as texture mapping or landmark detection. The rectified image and depth data are passed to block 720.

At block 720, a CV segmentation model identifies one or more human bodies with the RGB images and creates a mask to filter the depth data to segment the human body from the background. The system may implement one or more segmentation algorithms, including, but not limited to, depth thresholding, mask generation, or ML-based person detection, to isolate the human figure from surrounding background content. Following segmentation, the system executes block 725.

At block 725, the system converts the captured depth data into a 3D point cloud by projecting each pixel from the two-dimensional (2D) image plane into 3D space using intrinsic calibration parameters of the depth camera. As noted above, these intrinsic parameters may include, but are not limited to, the focal length (fx, fy), the principal point coordinates (cx, cy), and radial and tangential lens distortion coefficients. Using these parameters, the system computes the real-world 3D position of each pixel by transforming the 2D coordinates and corresponding depth value into a spatial coordinate (X, Y, Z) relative to the camera coordinate frame. The depth image, which consists of per-pixel depth values representing the distance between the sensor and surfaces in the scene, is aligned with a synchronized RGB image. Pixel-level data from both the RGB and aligned depth images are fused such that each 3D point in the point cloud not only represents geometric depth but is also associated with a corresponding RGB color value. The result is a colored 3D point cloud that reflects both the shape and surface texture of the captured subject.

This point cloud is generated for pixels classified as part of the foreground human body, based on segmentation output (e.g., a binary or part-based mask). As such, the generated point cloud selectively represents the surface geometry of the segmented human figure, including the torso, arms, and visible portions of the lower body. The 3D point cloud data is used as an intermediate representation for subsequent processes, such as mesh generation, surface analysis, and garment alignment operations. The point cloud is then passed to block 730.

At block 730, the system registers multiple partial point clouds, each generated from depth and RGB image pairs captured at different frames as the user rotates in front of the camera, into a unified and coherent 3D model. The point clouds are aligned using a combination of spatial registration techniques to ensure accurate surface continuity and global shape consistency across the full body scan. In some embodiments, the registration process includes a sequential ICP algorithm, which iteratively minimizes the Euclidean distance between overlapping regions of adjacent point clouds. The algorithm identifies point correspondences between successive scans and applies rigid or non-rigid transformations to align each new point cloud with the existing aggregated model.

To facilitate the initial alignment, particularly in regions with low geometric variation, the system may also implement visual-based registration using image features extracted from the RGB frames. For example, SIFT descriptors may be detected and matched across frames, allowing the system to compute relative camera poses and assist with initial transformation estimation between corresponding point clouds. In addition, pose graph optimization may be applied to globally refine the alignment. A graph is constructed where each node represents a camera pose associated with a captured frame, and each edge represents a spatial transformation between frames. The system detects loop closures, instances in which the camera revisits a previously observed viewpoint, and incorporates those constraints into the pose graph. Optimization of this graph using nonlinear least squares or similar methods minimizes accumulated drift and produces a globally consistent reconstruction of the subject’s 3D shape. The result of this multi-stage alignment process is a unified spatial model representing the complete surface geometry of the human body. This model maintains accurate spatial relationships across all views, enabling downstream processes, such as mesh fusion, surface smoothing, clothing simulation, and cross-sectional measurement analysis.

The alignment framework may further incorporate multi-modal correspondence information derived from both visual features and geometric surface measurements to improve the stability of the reconstruction process. The processor may combine feature-based registration derived from RGB image analysis with geometric alignment derived from depth-based point clouds. For example, feature correspondences identified using the SIFT algorithm may provide an initial estimate of relative frame orientation and translation between two frames. The processor may then apply geometric alignment algorithms, such as iterative closest point processing, to refine this estimate by minimizing distances between corresponding points within overlapping point clouds. This staged alignment approach reduces the likelihood that the geometric registration algorithm converges to an incorrect alignment when captured surfaces contain limited structural variation. Initializing geometric alignment with visually derived pose estimates improves convergence reliability when processing surfaces such as a torso region, a back region, and/or a garment-covered region that may exhibit limited geometric curvature.

The system may also incorporate temporal consistency checks across sequential frames to improve the pose estimation. The processor may evaluate motion vectors derived from pose sensor data and compare those vectors with pose transformations estimated through visual feature matching. When the estimated motion between frames exceeds a predefined threshold relative to the detected sensor motion, the processor may reject the candidate transformation and re-estimate the alignment using alternative feature correspondences. This process prevents propagation of erroneous pose estimates that may arise from incorrect feature matches, temporary occlusions, and/or background structures that appear visually similar across frames. Maintaining agreement between sensor-derived motion and image-derived pose estimation improves the stability of the alignment process. This consistency checking operation reduces drift that may otherwise accumulate when reconstructing a three-dimensional model from a large number of sequential frames.

The pose graph optimization stage may incorporate weighting mechanisms that prioritize transformations derived from higher-confidence correspondences. Transformations generated from frames containing a large number of matched visual features and strong geometric overlap may receive greater weighting during the optimization process. Transformations associated with frames containing fewer feature correspondences, sparse depth data, and/or partial occlusions may receive reduced weighting. During optimization, the processor evaluates the relative error between predicted spatial relationships and observed transformations across the graph. The processor then iteratively updates camera pose parameters associated with each node in the graph to minimize global error across the connected edges. This optimization process produces a spatial configuration of camera poses that remains consistent across the entire capture sequence and reduces cumulative alignment drift.

The globally optimized pose graph may then be used to transform each captured point cloud into a unified coordinate system representing the full three-dimensional geometry of the scanned subject. The processor may apply the optimized transformation parameters associated with each frame to reposition the corresponding point cloud within a global coordinate space. Once transformed, the point clouds may be aggregated to produce a unified spatial representation of the scanned body surface. This aggregated representation may contain dense surface samples corresponding to anatomical regions such as a shoulder contour, a waistline region, a hip surface, and/or a leg region captured from different viewpoints. Because the pose graph optimization process reduces spatial inconsistencies between frames, the resulting aggregated point cloud exhibits improved structural coherence across the reconstructed surface.

This multi-stage alignment and optimization process addresses technical challenges associated with reconstructing a continuous three-dimensional model from sequential sensor observations captured by a handheld device. Handheld scanning introduces variations in device orientation, user posture, and viewpoint that can cause misalignment between frames when processing RGB and depth data. Without global pose refinement, these misalignments accumulate over time and may produce distortions in the reconstructed geometry. The combination of feature-based registration, geometric refinement, and pose graph optimization reduces these distortions by continuously correcting pose estimates across the capture sequence. As a result, the reconstructed spatial model preserves consistent geometric relationships between anatomical regions captured in different frames.

The resulting unified spatial model provides several technical benefits for downstream processing within the reconstruction pipeline. Improved alignment accuracy increases the reliability of volumetric fusion and mesh reconstruction processes that depend on consistent spatial relationships between point clouds. Reduced drift improves the accuracy of cross-sectional slicing operations used to extract body measurements from the reconstructed mesh. Improved geometric consistency enhances the stability of garment alignment algorithms that position a virtual garment model relative to anatomical landmarks on the body mesh. The coherent spatial model also improves surface smoothing and collision detection operations performed during garment simulation. Accordingly, the alignment and pose optimization framework improves the operation of the computing system by producing a geometrically consistent representation of the scanned subject that supports reliable three-dimensional reconstruction and virtual garment fitting analysis.

At block 735, the system reconstructs an estimated 3D mesh of the human body using the previously registered point clouds. The reconstruction process converts the aggregated spatial data into a continuous geometric surface model that accurately represents the external contour of the segmented human subject. This may be accomplished using volumetric surface reconstruction techniques, such as TSDF integration, in which a voxel grid is constructed over the 3D space occupied by the registered point cloud. In a TSDF-based implementation, each voxel stores a signed distance value representing the estimated distance from the voxel center to the nearest surface boundary. Depth measurements from each point cloud frame are incrementally fused into this volumetric grid, enabling the system to accumulate and average surface observations across multiple views. Distance values are truncated beyond a pre-defined range to reduce the impact of noisy data and occlusions, improving mesh consistency.

Once the TSDF volume has been populated with integrated depth observations, the system extracts a surface representation of the scanned subject by applying a surface triangulation process to the volumetric grid. In some embodiments, the processor executes a surface extraction algorithm such as the Marching Cubes method to convert the volumetric representation into a polygonal mesh. The volumetric grid contains voxels that store signed distance values representing the distance between the voxel location and an estimated surface of the scanned subject. The processor evaluates these signed distance values across neighboring voxels to identify locations where the distance function transitions from a positive value to a negative value. These transitions correspond to surface boundaries within the volumetric representation and indicate where the reconstructed surface of the subject is located within the voxel grid.

During operation of the surface triangulation process, the processor analyzes each voxel cell formed by adjacent voxels within the three-dimensional grid. For each voxel cell, the processor determines a configuration pattern based on the signed distance values at the vertices of the voxel cell. The processor then references a predefined triangulation table that specifies how triangles should be generated for the detected configuration pattern. For example, if one vertex of a voxel cell has a positive signed distance value and an adjacent vertex has a negative signed distance value, the processor determines that the surface passes through the edge between those vertices. The processor computes an interpolated surface intersection point along the voxel edge and uses this point as a vertex in a generated triangle. By performing this analysis across neighboring voxel cells, the processor incrementally generates a connected set of triangle faces representing the reconstructed surface geometry.

As the triangulation process progresses across the volumetric grid, the processor connects adjacent triangle faces to form a continuous mesh surface. For example, triangles generated within neighboring voxel cells may share edges and vertices, allowing the processor to assemble a consistent mesh structure that approximates the outer surface of the scanned subject. This process produces a watertight mesh in which gaps between neighboring surfaces are minimized and adjacent triangle faces maintain consistent connectivity relationships. The resulting mesh may represent structural features of the scanned body such as a torso surface, a shoulder region, a waist contour, and/or a leg region derived from the aggregated depth measurements.

The triangulation process also improves geometric stability of the reconstructed model by filtering irregularities that may occur within the voxel grid due to sensor noise or incomplete depth observations. For example, when depth measurements contain small inconsistencies between frames, the interpolation and triangulation process smooths the reconstructed surface by generating triangle vertices at interpolated positions within the voxel grid rather than directly using noisy point cloud measurements. This produces a mesh surface that more closely approximates the underlying body geometry captured by the sensor.

Extraction of the mesh surface from the volumetric representation provides several technical improvements within the reconstruction pipeline. First, the triangulated mesh converts discrete voxel measurements into a continuous geometric representation that may be processed by downstream algorithms used for measurement extraction, anatomical landmark identification, and garment alignment. Second, the structured mesh representation improves computational efficiency for subsequent geometric analysis because surface operations may be performed on triangle faces rather than on large sets of unstructured point cloud samples. Third, the watertight mesh structure improves reliability of cross-sectional slicing operations used to calculate body measurements such as a chest circumference, a waist circumference, and/or a hip circumference. Fourth, the consistent triangle connectivity improves the stability of garment deformation and collision detection operations performed during virtual fitting simulations. Thus, the surface triangulation stage transforms the volumetric TSDF representation into a structured geometric model that improves accuracy, stability, and/or computational efficiency of the three-dimensional body reconstruction and analysis pipeline.

In other embodiments, mesh generation may be performed directly from the point cloud without first constructing a volumetric representation. In this approach, the processor receives an aggregated point cloud representing spatial coordinates derived from RGB image data and corresponding depth measurements captured over a sequence of frames. Each point in the point cloud represents a three-dimensional coordinate corresponding to a detected surface location of the subject. The processor analyzes spatial relationships between neighboring points in the point cloud to determine geometric connectivity between those points and to reconstruct a continuous surface representation of the scanned subject.

In some implementations, the processor may apply a Poisson surface reconstruction algorithm to estimate a continuous surface from the set of discrete spatial points. During this process, the processor computes local surface normals for points within the point cloud based on spatial orientation of neighboring points. These surface normals provide directional information describing the orientation of the surface at each sampled point location. The processor then solves a spatial reconstruction function that integrates the point positions and corresponding surface normals to generate an implicit surface representation that approximates the underlying geometry of the scanned subject. Once the implicit surface representation has been computed, the processor extracts a triangulated mesh that approximates the reconstructed surface by generating triangle faces between adjacent points that lie on the surface boundary.

In other implementations, the processor may perform mesh generation using Delaunay triangulation techniques applied directly to the spatial coordinates of the point cloud. In this process, the processor evaluates the spatial distribution of neighboring points and constructs triangles between sets of points that satisfy geometric constraints associated with Delaunay triangulation. For example, the processor may form triangles such that no point in the set lies inside a circumcircle defined by the vertices of another triangle. This constraint results in a triangulation that maximizes the minimum angle of triangle faces and reduces the likelihood of generating elongated or poorly shaped triangles that could distort the reconstructed surface geometry. In practice, the processor may evaluate the internal angles of each generated triangle and reject or refine triangles that fall outside acceptable geometric thresholds. For example, triangles may be generated so that a minimum internal angle of each triangle is maintained above a predetermined threshold, such as about 5 degrees to about 30 degrees, about 8 degrees to about 25 degrees, about 10 degrees to about 22 degrees, and in some implementations about 12 degrees to about 20 degrees. Maintaining this lower bound on triangle angles reduces the creation of narrow triangles with highly acute angles that may produce unstable mesh surfaces during reconstruction.

Similarly, the triangulation process may limit excessively obtuse triangle configurations by constraining maximum internal angles. For instance, the processor may enforce a maximum triangle angle threshold within a range of about 110 degrees to about 175 degrees, about 120 degrees to about 170 degrees, about 130 degrees to about 165 degrees, and in some embodiments, about 140 degrees to about 160 degrees. Limiting these larger angles helps maintain balanced triangle shapes across the mesh surface and reduces the likelihood that triangles will span overly large surface regions that could reduce geometric fidelity of the reconstructed model. By maintaining both minimum and maximum angular constraints, the triangulation process produces triangles that more uniformly approximate the curvature of the scanned surface.

The processor may further evaluate geometric proportions of each triangle by analyzing edge-length ratios between the triangle edges. For example, the ratio between the longest edge and the shortest edge of a triangle may be maintained below a predetermined threshold, such as about 2:1 to about 8:1, about 2.5:1 to about 6:1, about 3:1 to about 5:1, and in some implementations, about 3:1 to about 4:1. Limiting this ratio reduces the generation of elongated triangles that extend across sparse regions of the point cloud and distort the local surface geometry. These geometric constraints allow triangles to more closely follow the spatial distribution of point samples within the reconstructed dataset.

Additional geometric constraints may also be applied to control triangle surface area and spatial density within the mesh. For example, triangle areas may be constrained within ranges, such as about 0.5 square millimeters to about 50 square millimeters, about 1 square millimeter to about 30 square millimeters, and in some embodiments, about 2 square millimeters to about 20 square millimeters, depending on the resolution of the point cloud. In regions where the point cloud exhibits higher sampling density, smaller triangle areas may be generated to capture fine surface details. In regions with lower sampling density, larger triangles may be generated while maintaining the above angular constraints to preserve geometric continuity across the surface.

Application of these triangulation constraints improves the structural quality of the reconstructed surface mesh generated from the point cloud data. When triangles exhibit balanced internal angles, controlled edge-length ratios, and appropriate area ranges, the resulting mesh more accurately follows the curvature of the scanned body surface. For example, triangles generated across curved anatomical regions, such as a shoulder contour, a waist region, a hip surface, and/or a thigh region, may adapt smoothly to the underlying geometry captured by the sensor data. This improved geometric regularity reduces artifacts that may otherwise appear when triangles stretch across irregular point distributions or sparse sampling regions.

Maintaining these triangulation constraints also improves the reliability of downstream computational processes performed on the mesh. Mesh smoothing algorithms, anatomical landmark detection algorithms, garment alignment procedures, and cross-sectional measurement calculations rely on consistent geometric connectivity between neighboring triangles. Triangles with extreme angles or disproportionate edge lengths may introduce irregularities that interfere with these processes. By generating triangles within defined geometric ranges, the triangulation process produces a mesh structure that supports stable geometric analysis and improves the accuracy of body measurement extraction and virtual garment fitting operations performed on the reconstructed three-dimensional model.

The processor may further evaluate connectivity relationships between generated triangles to identify and refine surface regions that correspond to the subject. For example, the processor may detect clusters of triangles that represent coherent surface regions corresponding to anatomical portions of the body, such as a torso surface, a shoulder region, an arm contour, and/or a leg surface. Triangles that do not belong to these coherent clusters may correspond to isolated point cloud noise or background artifacts and may be removed from the mesh representation. This refinement process produces a consistent surface mesh that more accurately reflects the physical geometry of the scanned subject.

The resulting mesh provides a structured and manipulable three-dimensional representation that supports downstream computational tasks within the reconstruction pipeline. For example, the processor may analyze curvature and surface topology of the mesh to identify anatomical landmark locations such as a shoulder point, a waist contour, and/or a hip boundary. The processor may also perform cross-sectional slicing operations across the mesh to determine body measurements corresponding to specific anatomical regions. In addition, the mesh representation allows a three-dimensional garment model to be spatially aligned to the body surface using corresponding landmark points or attachment regions.

These mesh generation techniques address technical challenges associated with reconstructing continuous surfaces from unstructured point cloud data captured by mobile depth sensors. Raw point clouds often contain irregular sampling densities, missing regions caused by occlusions, and measurement noise introduced by the depth-sensing hardware. By applying geometric reconstruction algorithms such as Poisson surface reconstruction and Delaunay triangulation, the processor converts the unstructured set of spatial points into a connected triangular surface that approximates the underlying body geometry while smoothing irregularities in the sampled data.

The use of these mesh generation techniques provides several technical benefits within the described system. First, reconstruction of a connected triangular mesh improves the stability of geometric analysis performed on the scanned body, including measurement extraction and anatomical landmark identification. Second, the structured mesh representation reduces computational complexity during downstream processing by allowing algorithms to operate on connected triangle faces rather than on large sets of unstructured point samples. Third, the improved geometric continuity of the mesh increases the accuracy of garment alignment and deformation simulations used during virtual fitting operations. Fourth, the triangulated mesh structure supports efficient rendering and visualization of the reconstructed body model within a mobile device application. Accordingly, the mesh reconstruction process improves the functioning of the computing system by transforming unstructured point cloud data into a geometrically coherent surface model that supports reliable body analysis and virtual garment fitting operations. The system then extracts body measurements at block 740.

At block 740, the system extracts one or more anatomical body measurements from the reconstructed 3D mesh of the human subject. In particular, the mesh is analyzed to derive cross-sectional perimeter values at anatomically relevant heights, such as the chest, waist, and hips. These measurements are used to characterize the user’s body shape and may support applications such as virtual garment sizing, fitness tracking, or avatar generation. To perform this measurement extraction, the system may determine a set of vertical positions along the longitudinal (Y-axis) direction of the mesh at which horizontal slices will be taken. These slice levels may correspond to one or more predetermined anatomical landmark regions and/or may be dynamically estimated based on body proportions, segmentation labels, and/or user input.

At each designated slice level or at one or more predefined slice levels, a horizontal slicing plane may be defined within the coordinate system of the reconstructed mesh and intersected with the 3D mesh to produce a closed or semi-closed cross-sectional contour corresponding to a portion of the body surface. The slicing plane may be positioned at a selected height relative to the vertical axis of the reconstructed mesh, and the processor may evaluate intersections between the plane and the triangular faces of the mesh. For example, the processor may determine which triangle edges cross the defined slicing plane by evaluating whether vertices of the triangle lie above and/or below the plane within the three-dimensional coordinate space. When a triangle edge spans the slicing plane, the processor calculates an interpolated intersection point along that edge. These intersection points collectively represent locations where the slicing plane intersects the surface geometry of the reconstructed body.

The processor may then connect the intersection points generated from adjacent triangle faces to form a continuous intersection curve that traces the boundary of the body surface at the selected slice level. For example, the intersection curve may correspond to a horizontal contour around a torso region, a waist region, a hip region, and/or another anatomical location of interest. In some cases, the contour may form a closed loop when the slicing plane intersects a continuous portion of the body surface, such as a cross-section of the torso. In other cases, the contour may form a semi-closed or partially open curve when the slicing plane intersects a region containing incomplete surface data or areas partially occluded during the capture process. The resulting set of three-dimensional points defining the intersection curve represents the geometric boundary of the body surface at that particular slice level.

In some embodiments, the system may generate multiple slicing planes positioned at different vertical intervals to analyze cross-sectional geometry across the body. For example, a slicing plane positioned near an upper torso region may intersect the mesh to generate a contour corresponding to a chest circumference. A slicing plane positioned slightly lower along the vertical axis may generate a contour corresponding to a waistline measurement. Similarly, a slicing plane positioned near a hip region may produce a contour representing a hip circumference, while additional slices may correspond to a thigh region, an upper arm region, and/or a calf region. These slice levels may be predetermined based on anatomical reference points or may be dynamically selected based on detected body landmarks within the mesh.

The processor may also analyze the intersection curves to determine geometric characteristics of the cross-section. For example, the processor may compute a perimeter value by measuring the cumulative distance between successive intersection points along the contour. The processor may also evaluate additional geometric attributes of the cross-section, such as curvature distribution, contour symmetry, and spatial offsets relative to anatomical landmarks. These measurements may provide information describing the shape and proportions of the body at the selected slice level. In certain embodiments, the processor may smooth the contour by applying interpolation or curve-fitting techniques to reduce irregularities that may result from noise in the underlying mesh geometry.

The cross-sectional contours generated through this slicing process may be used for one or more downstream operations within the reconstruction and garment fitting system. For example, the computed perimeter values may be used to estimate body measurements relevant to garment sizing and fit evaluation. The contour geometry may also assist in identifying anatomical landmarks by detecting characteristic shape features, such as narrowing at a waist region or widening at a hip region. In addition, the cross-sectional data may be used to align garment models with the body mesh by matching garment reference dimensions with corresponding contour measurements. By generating and analyzing these intersection curves across multiple slice levels, the system obtains detailed geometric information describing the body shape that supports accurate measurement extraction and virtual garment fitting operations.

In some embodiments, a local 2D projection is applied to map the intersection points to a planar coordinate system, facilitating geometric analysis. Once the slice is extracted, the system calculates the perimeter of the cross-sectional shape using geometric algorithms such as polygonal chain length computation or spline interpolation. These perimeter values represent the circumferential dimensions of the body at that specific height. For example, a slice taken at the mid-abdomen may be used to compute the waist circumference, while a slice across the upper torso may yield the chest perimeter. In some embodiments, the system may also compute additional metrics from the slices, such as cross-sectional area, diameter, aspect ratio, and/or elliptical fit parameters, to further characterize the shape of a body of the user. These metrics may be used for garment fitting logic, body classification, and/or health monitoring purposes, for example. The results of the slicing and measurement process are stored and optionally visualized for the user, providing accurate and reproducible body dimensions derived from the personalized 3D mesh.

At block 745, the system aligns the reconstructed 3D body mesh of the user with a corresponding 3D model of a garment. This alignment process involves fitting the virtual garment to the user’s unique anatomical geometry by using predefined attachment points on the garment model and matching them to detected body landmarks on the reconstructed mesh. The body mesh is generated from prior steps involving RGB and depth image processing, point cloud registration, and surface reconstruction, and provides a personalized representation of the user’s body shape, proportions, and posture. Detected body landmarks, such as the shoulders, collarbones, armpits, waist, hips, and torso midline, are identified through automated or semi-automated techniques, including geometric analysis, anthropometric models, or machine learning-based landmark detection.

Each 3D garment model includes one or more attachment points that correspond to expected positions on the human body (e.g., neckline to neck base, sleeve shoulder seams to acromion, waistband to waistline). The system computes a transformation matrix for aligning the garment’s attachment points with the corresponding body landmarks. This transformation may include translation, rotation, non-uniform scaling, and, in some embodiments, mesh deformation to better conform the garment to body curvature and pose. The alignment procedure may be further refined using iterative fitting algorithms, such as ICP or energy-based deformation models, to minimize spatial error between the garment mesh and the surface of the body mesh. In some implementations, physics-based simulation may also be applied to evaluate garment drape, tension, and/or stretch characteristics, improving the realism and accuracy of fit representation.

The technical effect of this alignment process is the creation of a personalized, anatomically accurate virtual garment fitting experience that adapts the digital clothing model to the exact morphology of each user. By implementing body landmarks and attachment points rather than relying solely on generic scaling, the system provides a more precise virtual fit simulation that better captures differences in individual posture, body shape, and/or garment style. This enables downstream applications such as size prediction, garment personalization, virtual try-on visualization, and/or predictive fit confidence scoring.

At block 750, the system renders a composite visual output comprising the reconstructed 3D mesh of the user and a digitally fitted garment. This rendering is displayed at a user interface of an electronic device, such as a smartphone, a tablet, a laptop, a desktop computer, and/or a web-based viewer. The rendered scene functions as a virtual fitting room and/or a virtual avatar interface, allowing the user to view, inspect, and/or interact with the personalized digital representation wearing the simulated garment.

The 3D rendering engine, which may be implemented using a graphics framework to composite a digital human body model with the 3D garment mesh that has been previously aligned using anatomical landmark-based attachment logic. The combined model is rendered with lighting, shading, and texturing effects to provide a realistic visual representation of the garment fit and body shape.

In some embodiments, the display interface allows the user to rotate, zoom, and pan the avatar, enabling full 360-degree inspection of the garment fit across various regions of the body. The system may also render measurement guides, such as slicing planes, bounding boxes, or perimeter overlays, to help users visualize dimensions at specific locations (e.g., waist, chest, hips). The user interface may additionally include interactive elements, such as sliders to adjust measurement height, dropdowns to select garment styles or sizes, and highlighted regions to indicate areas of tight or loose fit.

In certain implementations, garment behavior may be visualized in response to body shape or pose, using physics-based cloth simulation, stretch maps, or collision detection to reveal how the digital garment conforms to or departs from the user’s mesh in real-time. Color-coded overlays may indicate garment tension zones, ideal alignment, or areas where fit deviations exceed preset thresholds.

As used herein, the term “align” may refer to the process of positioning, orienting, and/or, in some embodiments, scaling the 3D garment, such as a digital garment model, relative to a 3D mesh of a human body or a portion thereof. The alignment process may include spatial registration of the garment model to the anatomical geometry of the 3D mesh, such that corresponding regions (e.g., shoulders, waist, hips) of the garment and the body mesh are matched. In some embodiments, alignment may be performed using rigid or non-rigid transformation techniques, including but not limited to pose estimation, feature-based matching, or ICP registration algorithms. Alignment may also account for the orientation and pose of the user, as determined from depth data or skeletal tracking, to ensure the garment conforms realistically to the 3D mesh. Additionally, alignment may incorporate external contextual inputs, such as GPS location, to influence the selection or adjustment of the garment model to regional sizing standards or environmental factors. The goal of alignment is to enable accurate and realistic visualization of the garment on the user's virtual representation for purposes including virtual fitting, simulation, or measurement extraction.

The technical effect of this rendering process is to provide the user with a personalized and interactive virtual try-on experience, which simulates how a garment would fit and appear on the actual body shape, without requiring physical apparel. This visualization enhances user confidence in online clothing purchases, reduces size-related returns, and supports better garment selection through visual and quantitative feedback. Moreover, the rendering process described herein allows retailers and end users to engage in remote, data-driven fit evaluations, supporting broader adoption of contactless apparel shopping and digital customization workflows.

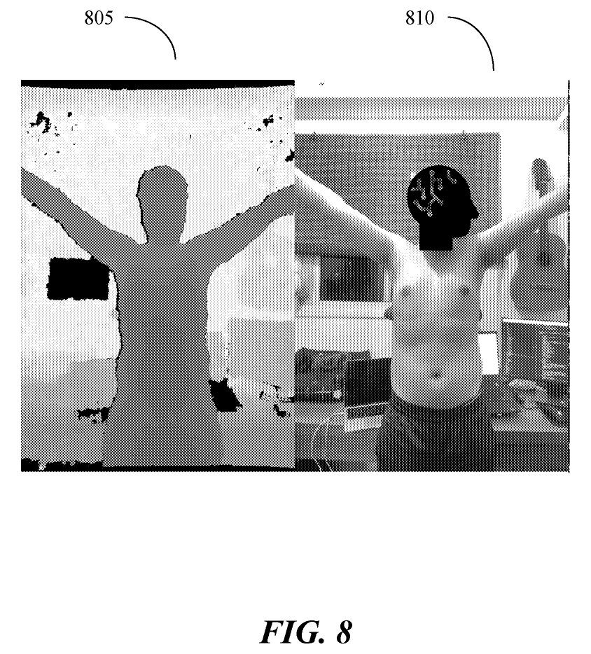

FIG. 8 shows a visual comparison of synchronized depth and RGB image data used in generating a 3D model of a human subject. The left side of the figure presents a depth map 805, while the right side shows the corresponding RGB image 810 captured at the same time. In this example, the subject is positioned in front of the TrueDepth camera with both arms extended laterally in a "T-pose" posture, facilitating full-body silhouette capture. The RGB and depth data are acquired simultaneously and aligned spatially using intrinsic calibration parameters of the camera system. In the depth image on the left, grayscale intensity represents the distance from the sensor to the subject, where lighter tones correspond to regions closer to the camera. The contours of the subject’s body and arms are clearly visible, enabling silhouette extraction and point cloud generation. The image has been rectified and undistorted using the intrinsic camera parameters and distortion maps of the electronic device, ensuring spatial accuracy across the field of view. On the right side, the RGB image shows the raw color data associated with the same scene. This image is used for color texture mapping, visual confirmation, and potential integration with one or more CV algorithms such as body landmark detection or segmentation.

The depth and RGB image pair serve as synchronized input for a Python-based application that may generate a 3D mesh of the human body. Depth pixels are projected into 3D space using known intrinsic parameters, forming a point cloud. These point clouds are registered across multiple frames using alignment techniques such as ICP and volumetric fusion (e.g., TSDF) to create a watertight 3D model. This implementation allows for accurate body reconstruction in consumer environments using only a front-facing depth camera and standard RGB sensor found on mobile devices.

In some embodiments, the subject’s pose may be optimized to expose a greater surface area of the body to the sensor, enabling more complete mesh generation. The calibration between RGB and depth streams ensures that each depth point can be associated with a corresponding color value and potential anatomical feature, improving the fidelity of the resulting 3D model.

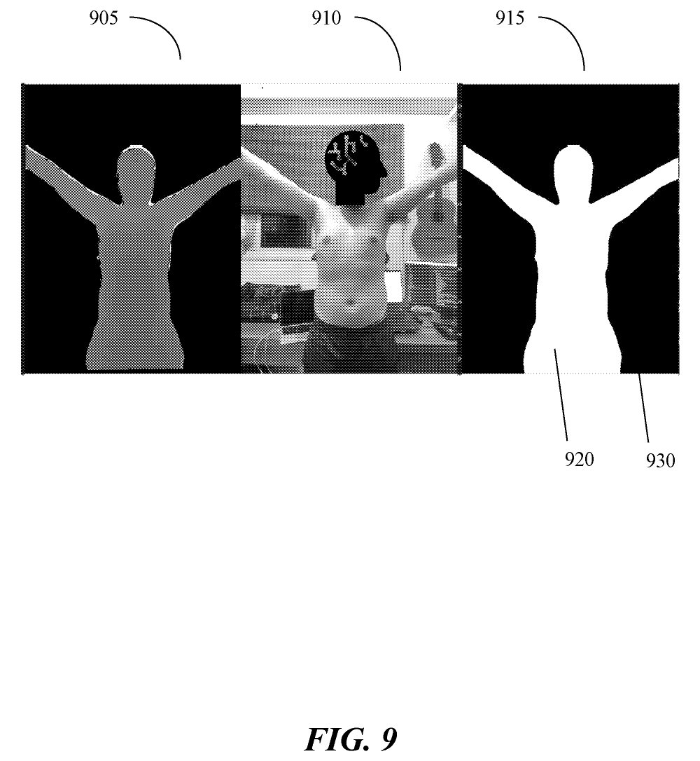

FIG. 9 shows a three-panel view demonstrating the semantic segmentation process applied to a depth image, an RGB image, and a resulting binary segmentation mask. This process enables the system to isolate the human subject within the frame for more accurate 3D reconstruction and measurement. The left panel displays a depth image 905 of the subject, where pixel intensity represents the distance between the subject and the depth-sensing camera. This depth map is used in conjunction with RGB data to generate 3D information. The depth image includes both the subject and surrounding background objects, which may introduce noise into the reconstruction process if not filtered appropriately. The center panel 910 depicts the corresponding RGB image of the subject in a capture-ready pose, with arms extended outward. This image is used for both texture alignment and visual confirmation, and it serves as the input for the CV segmentation model. The right panel 915 illustrates the output of a semantic segmentation model, where the human body has been isolated from the background using a binary classification mask. In this binary mask, each pixel identified as belonging to the human subject 920 is highlighted (e.g., in white), while the background pixels 930 are suppressed (e.g., in black). This segmentation model is implemented using a neural network-based architecture or a similar CV framework and detects the edges and contours of the subject and applies the mask accordingly.

The segmentation mask may be applied to the captured depth data to filter the depth measurements associated with the scene. During this process, the processor evaluates the segmentation mask generated from the RGB image and determines which pixels correspond to the detected human body and which pixels correspond to background regions. Depth pixels associated with background regions may be excluded from further processing by the reconstruction pipeline. As a result, only depth values associated with the segmented human body region are retained for conversion into spatial coordinates. For example, depth measurements corresponding to surrounding objects, such as a wall, a floor surface, a chair, and/or other environmental structures, may be discarded prior to point cloud generation. This filtering process produces a depth dataset that primarily represents the surface geometry of the subject’s body rather than the surrounding scene.

The filtered depth data may then be used to generate a point cloud representation corresponding specifically to the subject. The processor converts each retained depth pixel into a three-dimensional spatial coordinate based on intrinsic parameters of the imaging device, such as focal length and principal point coordinates. Because the background depth pixels have been removed, the generated point cloud contains spatial samples corresponding predominantly to the body surface. For example, the point cloud may include spatial points corresponding to regions such as a torso surface, a shoulder region, a hip contour, and/or a leg surface, while excluding points corresponding to background structures in the capture environment. This subject-focused point cloud reduces the likelihood that unrelated geometry will be incorporated into the reconstructed model.

Removal of background depth measurements also improves the stability of downstream reconstruction algorithms. When background surfaces are present within the point cloud, registration algorithms may incorrectly align those surfaces across frames, which can introduce distortions into the reconstructed geometry. By restricting the point cloud generation process to pixels belonging to the segmented human body region, the system reduces the number of extraneous points that could interfere with point cloud alignment and mesh reconstruction operations. For example, surfaces corresponding to a wall behind the subject or reflective objects in the scene are excluded from geometric processing, reducing the possibility that those structures influence frame-to-frame alignment.

This segmentation-based filtering process also improves the reliability of anatomical landmark detection and body measurement extraction performed on the reconstructed mesh. When background geometry is incorporated into the mesh, measurement algorithms may misinterpret environmental structures as part of the body surface. For instance, a background surface located behind the subject could alter the contour detected during cross-sectional slicing operations. By isolating the subject prior to point cloud generation, the system produces a mesh representation that corresponds more closely to the actual body geometry of the user. As a result, landmark detection processes can more accurately identify anatomical regions, such as shoulder points, waist contours, and hip boundaries, within the reconstructed model.

The segmentation mask also contributes to improved computational efficiency during the reconstruction pipeline. Because the processor converts only the segmented body pixels into three-dimensional points, the number of spatial points processed during registration, volumetric fusion, and mesh reconstruction is reduced. This reduction in processed data decreases computational overhead associated with point cloud alignment and mesh generation algorithms. For example, eliminating background depth pixels corresponding to static environmental structures may reduce the total number of processed points by a substantial margin when scanning in a typical indoor environment. Consequently, the segmentation stage contributes to faster processing times and reduced memory usage within the reconstruction system.

Through these operations, the segmentation mask functions as a preprocessing mechanism that isolates body-related depth measurements and removes environmental interference from the captured sensor data. The resulting subject-specific depth representation supports more stable point cloud generation, improved alignment across frames, and more accurate mesh construction. These improvements enhance the quality of the reconstructed three-dimensional body model and support downstream processes such as body landmark identification, garment alignment, and/or cross-sectional measurement analysis within the virtual fitting system.

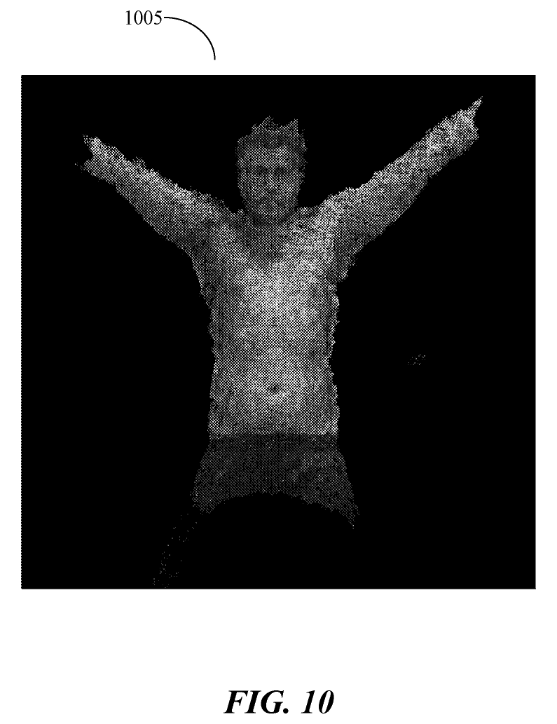

FIG. 10 depicts a 3D point cloud 1005 of a human subject, reconstructed from depth and RGB images using intrinsic calibration parameters of a depth-sensing device. The figure depicts the result of projecting depth pixels into 3D space to form a point cloud that represents the surface geometry of the subject’s body. In this embodiment, pixel-level depth values are captured using a depth-sensing camera, such as the TrueDepth camera integrated with the mobile device, and are mapped from 2D image space into 3D world coordinates using intrinsic calibration parameters of the camera system. The intrinsic calibration data used to generate the point cloud includes the focal lengths (fx, fy), principal point offsets (cx, cy), and, in some implementations, lens distortion coefficients that correct for radial or tangential distortion. These parameters allow each depth pixel to be accurately projected into a 3D space as a coordinate point (X, Y, Z) relative to the camera origin. The figure depicts the result of this transformation process: a colorized 3D point cloud representing the surface geometry of the segmented human body. Each point in the cloud corresponds to a pixel from the aligned RGB image and carries color information that visually represents skin tone, clothing, and other visible surface features. This fusion of geometry and texture provides a rich dataset for downstream processing, including mesh reconstruction, garment simulation, and measurement extraction.

The human subject shown in FIG. 10 is in a T-pose with arms extended horizontally, which enhances coverage of the upper body, reduces self-occlusion, and aids in the accuracy of landmark detection and surface contouring. The point cloud includes detailed data across the torso, arms, chest, and upper waist regions, and is generated only for pixels corresponding to the segmented human body, excluding background and environmental artifacts. This 3D point cloud serves as an intermediate data structure that may be subsequently processed using volumetric integration algorithms, such as TSDF fusion, or used directly for non-rigid alignment, body landmark estimation, or garment fitting applications. The level of geometric fidelity and color alignment in the point cloud directly supports personalized body modeling in mobile-enabled virtual fitting systems.

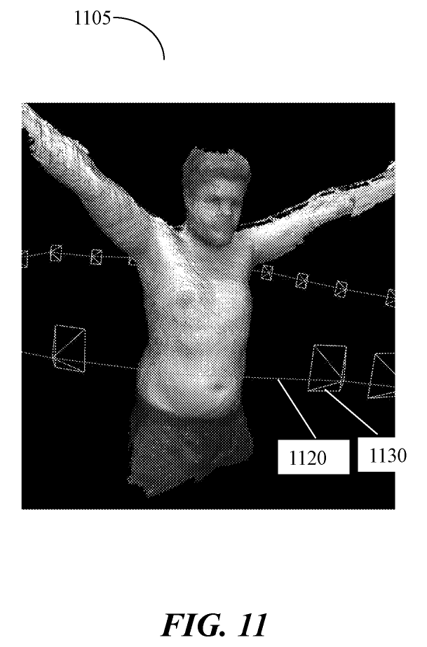

FIG. 11 depicts a 3D mesh 1105 of a human subject, generated through the alignment 1120 and registration of multiple point clouds 1130 captured as the subject rotates in place. The figure demonstrates the result of a complete reconstruction pipeline in which individual point clouds, each corresponding to a different camera viewpoint, are merged into a coherent, unified 3D model. In this example, a depth-sensing camera captures a sequence of RGB and depth frames as the subject maintains a fixed pose and gradually rotates in front of the sensor. Each depth frame is individually converted into a partial 3D point cloud as described previously with reference to FIG. 10. These partial point clouds are then registered to one another using spatial alignment techniques. The registration process, in an example embodiment, may include a sequential ICP algorithm that minimizes the Euclidean distance between corresponding points in overlapping regions of adjacent point clouds. Additionally, visual-based registration is performed using SIFT (Scale-Invariant Feature Transform) features extracted from synchronized RGB images. These features help establish visual correspondences across frames, improving the initial alignment.

To further refine the reconstruction and eliminate drift that can accumulate in sequential registration, the system implements pose graph optimization with loop closure detection. In this process, the poses of individual frames are organized into a graph, where nodes represent camera positions and edges represent spatial transformations. When the system detects that the camera has returned to a previously observed position, a loop closure constraint is introduced, allowing global adjustments to the model for improved consistency and accuracy. The result, as shown in FIG. 11, is a registered 3D mesh with consistent surface continuity and high-fidelity anatomical detail. The model accurately captures the geometry of the subject’s upper body, including facial features, torso curvature, and extended arms. The rendering also includes visible visual cues indicating prior camera positions (shown as semi-transparent wireframe boxes), which reflect the camera trajectory used during data acquisition. This mesh serves as the foundation for downstream processes such as surface reconstruction, garment simulation, and body measurement extraction, and may be exported in formats compatible with 3D analysis or virtual try-on environments.

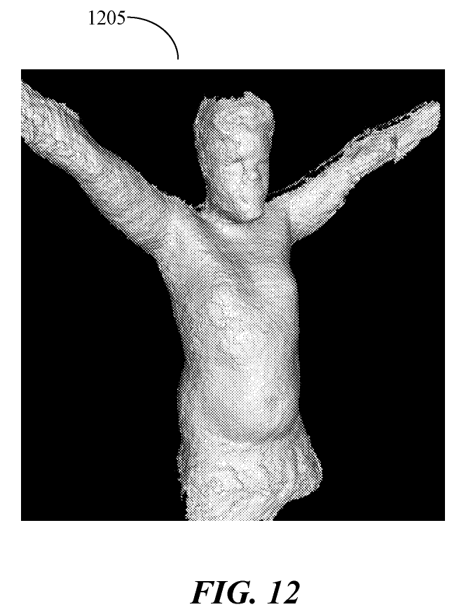

FIG. 12 depicts a 3D mesh model 1205 of a human subject, reconstructed from a globally registered point cloud using volumetric integration. The mesh may be generated using, including but not limited to, a TSDF, a commonly used method in 3D surface reconstruction to produce continuous, smooth surfaces from discrete point cloud data. In this embodiment, multiple point clouds captured during user rotation were previously aligned into a unified spatial model using techniques such as ICP, SIFT-based visual feature matching, and pose graph optimization, as described in connection with FIG. 11. The integrated point cloud serves as the input to the TSDF pipeline. A TSDF volume may be constructed by dividing the reconstruction space into a voxel grid, where each voxel stores a signed distance value representing the distance between the voxel center and the nearest surface point. Values may be truncated within a defined range to suppress noise and mitigate the effects of sensor inaccuracies. Depth measurements from one or more frames may be fused into a voxel representation to accumulate consistent surface estimates.

Once the TSDF volume is completed, a surface extraction algorithm, such as Marching Cubes, is applied to convert the volumetric data into a triangulated mesh. The mesh in FIG. 12 is rendered without texture to emphasize the geometric structure. It demonstrates smoothed and continuous surfaces, showing fine anatomical detail such as the curvature of the torso, shoulders, and arms. Additionally, the mesh may undergo one or more refinement operations to remove noise and outliers. These may include, but are not limited to, statistical outlier removal, z-score filtering, and/or connected component analysis to preserve the largest contiguous mesh, typically corresponding to the human body. This mesh serves as the basis for further processing steps, such as anatomical landmark detection, virtual garment fitting, and/or cross-sectional perimeter measurement. The nature of the mesh allows for reliable slicing operations and volume-based calculations, enhancing the accuracy and applicability of the reconstructed model in downstream applications.

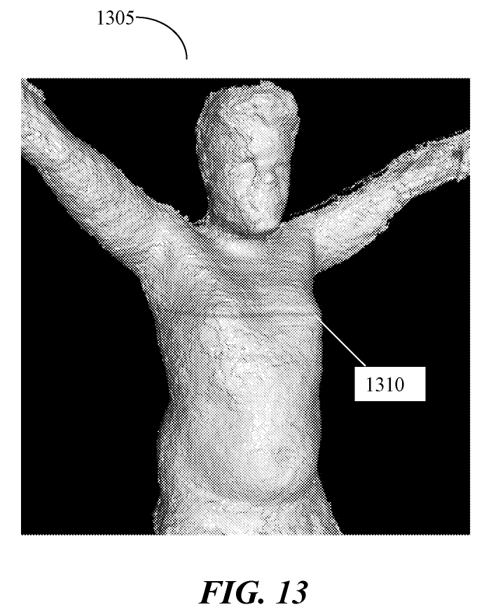

FIG. 13 depicts a 3D mesh of a human subject rendered within a measurement interface 1305, where a horizontal slicing plane 1310 is visually overlaid across the torso at a user-defined height. In this embodiment, the mesh has been previously reconstructed from depth and RGB input data and rendered on an electronic device. The mesh is positioned using the bounding box center to ensure consistent alignment and spatial context across different users and scans. The horizontal slicing plane 1310 intersects the mesh at the chest region. In an embodiment, this slicing plane may be dynamically adjusted by user input through a slider interface (not shown), which maps to a discrete set of measurement heights stored in a database of files, including, but not limited to, a perimeter JSON file. Each slider value corresponds to a pre-computed cross-sectional perimeter value derived from horizontal slices of the mesh. In an example, as the user adjusts the slider, the slicing plane moves up or down in the Y-axis direction, and the associated measurement is updated and displayed in real time, for example, in inches and/or centimeters. This method enables users to interactively select the anatomical region they wish to measure, such as the waist, hips, and/or chest, rather than relying on a fully automated or fixed measurement routine. The interactivity increases user control and improves measurement accuracy, especially in cases where landmark detection may be uncertain due to pose variation or body morphology.

In some embodiments, the system may utilize a machine learning model to interpret each cross-sectional slice and predict anthropometric measurements that account not only for perimeter but also for shape deformation, pose, and soft tissue characteristics. This approach may be applied in addition to or as an enhancement to raw geometric perimeter calculations. For example, the model may infer standardized waist circumference based on learned correlations between 3D contour features and labeled anthropometric training data. Additionally, the interface may incorporate tap or touch gestures allowing users to select anatomical landmarks directly on a holographic overlay of the 3D avatar. Upon selection of a body point, such as the navel, sternum, and/or armpit, for example, the system may automatically position the slicing plane or compute distances and circumferences between selected features.

In some implementations, the 3D body mesh generated from the reconstruction pipeline may be transformed into a compressed feature representation before transmission or storage. Rather than transmitting the full geometric mesh containing vertex coordinates and triangle connectivity data, the processor may convert the mesh into a lower-dimensional numerical representation referred to as a feature vector or latent code. This transformation may be performed using a trained encoding model that analyzes geometric characteristics of the mesh and produces a compact representation capturing structural attributes of the body geometry. For example, the encoder may evaluate surface curvature distributions, spatial relationships between anatomical landmarks, cross-sectional measurements, and global body proportions derived from the reconstructed mesh. These geometric attributes may then be mapped into a reduced-dimensional feature vector that preserves information necessary for downstream garment fitting analysis while omitting direct reconstruction details of the original mesh geometry.

The encoding process may be implemented using a neural network–based autoencoder architecture in which an encoder model receives the mesh representation and generates a latent feature vector representing the underlying body shape. During operation, the encoder processes the mesh data by analyzing vertex positions, surface normals, and connectivity relationships between neighboring triangles. Through a sequence of computational layers, the encoder extracts geometric features describing the body surface and compresses those features into a numerical vector of reduced dimensionality. For example, a mesh containing tens of thousands of vertex coordinates may be represented by a feature vector containing a smaller number of parameters that summarize body shape characteristics, such as torso proportions, limb curvature, and waist-to-hip ratios. Because the resulting representation no longer contains explicit mesh topology information, the encoded feature vector does not directly reveal the original surface geometry of the scanned subject.

Transmission of the encoded feature vector may improve both data security and communication efficiency when interacting with remote systems. The reduced dimensionality of the encoded representation allows the system to transmit body shape information over network connections using less bandwidth compared with transmitting full mesh files. For example, a feature vector representing body geometry may require only a small fraction of the storage required for a high-resolution triangular mesh. The feature vector may therefore be transmitted to a remote server associated with a virtual garment fitting platform, where the server may perform garment matching, garment size prediction, and/or fit confidence analysis using the encoded representation. Because the feature vector represents an abstracted geometric description of the body, the remote system may perform these analyses without requiring direct access to the original detailed mesh geometry.

In certain implementations, reconstruction of the original mesh geometry from the encoded representation may require a corresponding decoding model that possesses access to trained decoding parameters. The decoder may transform the latent feature vector back into a reconstructed mesh representation by reversing the encoding process and estimating vertex coordinates and surface connectivity relationships based on the encoded features. Access to the decoder may be restricted to authorized computing systems, thereby preventing unauthorized parties from reconstructing the original body mesh from the transmitted data. For example, the mobile device that captures the scan may locally store the decoding model while transmitting only the encoded feature vector to external services. In this configuration, remote systems may perform garment recommendation and sizing operations using the encoded representation while the full body mesh remains accessible only within the trusted device environment.

This encoding framework introduces several technical benefits within the body reconstruction and virtual fitting system. Transformation of the mesh into a compressed latent representation reduces storage requirements and network transmission overhead associated with high-resolution three-dimensional models. The encoded representation also improves privacy protection by preventing direct exposure of detailed body geometry during communication with remote systems. In addition, the latent feature vector may provide a standardized representation of body shape that allows multiple external systems to perform garment analysis and fit evaluation without requiring compatibility with a specific mesh topology or file format. As a result, the encoding and decoding architecture improves the efficiency, security, and interoperability of the computing system while preserving the ability to perform accurate garment fitting analysis using reconstructed body geometry.

To further enhance reliability and contextual awareness, the system may also classify clothing style and scanning context using image metadata and visual analysis of the captured frames. During operation, the processor may analyze visual characteristics present in the RGB image data to determine properties of clothing worn by the subject. For example, the processor may evaluate surface contours of the reconstructed body mesh, color distribution within the RGB images, and texture patterns present on the garment surface. Based on these observations, the processor may determine whether a garment conforms closely to the body geometry or exhibits greater separation from the body surface. A garment that closely follows the body contour, such as a fitted athletic shirt or compression garment, may be classified as tight-fitting, while garments that exhibit visible folds, draping behavior, and larger spatial offsets from the body surface may be classified as loose-fitting clothing. This classification may assist the system in determining how measurement values derived from the reconstructed mesh should be interpreted, particularly in regions where clothing thickness or draping may influence the observed surface geometry.

The processor may perform this clothing style classification using visual features derived from the captured frames and geometric characteristics derived from the reconstructed mesh. For example, the processor may detect regions where the mesh surface closely corresponds to anatomical curvature of the body, which may indicate minimal clothing interference. Alternatively, the processor may identify areas where the mesh surface exhibits larger deviations from expected anatomical contours due to fabric draping, folds, and/or layered clothing. Image features such as shading variations, edge boundaries, and texture gradients may also provide information indicating whether clothing is stretched tightly across the body or loosely suspended. By evaluating these geometric and visual indicators, the system may classify the clothing style and apply corresponding measurement interpretation rules during body dimension analysis and garment fitting simulation.

In addition to clothing style classification, the system may analyze contextual information associated with the capture environment in order to improve the reliability of the reconstruction process. The processor may examine metadata associated with the captured images, such as device location data, capture time information, and device orientation data, to determine characteristics of the scanning environment. For example, location information derived from positioning systems may indicate whether the capture session occurs in an indoor environment, a residential environment, a fitness facility, and/or an outdoor setting. Visual analysis of the captured frames may further support environment classification by identifying environmental features such as exercise equipment, furniture, walls, floor surfaces, and/or natural outdoor elements present within the background of the images.

Contextual classification of the scanning environment may assist the system in adapting reconstruction parameters and garment fitting analysis to conditions present during capture. For example, if the captured frames contain visual indicators of a gym environment, such as exercise machines or mirrors, the system may anticipate the presence of athletic clothing and apply fitting models appropriate for performance garments. Similarly, detection of a residential environment, such as a bedroom or living area, may indicate casual clothing and corresponding garment fitting expectations. Outdoor environments may present different lighting conditions and background textures that influence segmentation and feature detection processes. By identifying these contextual conditions, the system may adjust segmentation thresholds, feature detection sensitivity, and/or garment fitting models used during the reconstruction pipeline.

The integration of clothing style classification and environmental context analysis provides several technical benefits within the described system. Identification of clothing style allows the system to distinguish between surface geometry that corresponds directly to the body and surface geometry influenced by garment draping, thereby improving interpretation of extracted measurement values. Context recognition may assist the processor in selecting appropriate reconstruction parameters that improve segmentation reliability and feature detection performance under varying environmental conditions. Additionally, environment classification may help reduce reconstruction errors caused by visually complex backgrounds and varying illumination conditions. These contextual awareness mechanisms improve the reliability of body reconstruction, measurement extraction, and virtual garment fitting operations performed by the computing system.

These contextual insights may be used to adjust measurement confidence, recommend optimal scanning conditions, or filter measurement results for quality assurance.

### EXAMPLE 1

This example describes some embodiments of a comprehensive system architecture and processing pipeline for generating accurate 3D models of the human body from RGB-D image data, as referenced in FIGS. 1–6. As used herein, the term “RGB-D” refers to image data that includes both color image information and corresponding depth information. The RGB component represents color image data captured using red, green, and blue color channels of an image sensor, while the depth component represents distance measurements indicating a distance between the image sensor and one or more surfaces within a captured scene. The depth information may be obtained using one or more depth sensing technologies, such as structured light sensing, time-of-flight sensing, stereo depth estimation, and/or other depth sensing techniques. In an RGB-D image frame, each pixel location may therefore be associated with both a color value and a corresponding depth value, allowing the computing system to determine three-dimensional spatial positions of observed surfaces. This combined color and depth information may be used by the processor to generate point clouds, perform segmentation, align captured frames, and reconstruct a three-dimensional mesh representing the human body. In these embodiments, the system implements a depth-sensing camera, such as a TrueDepth camera, along with pose sensors and advanced computer vision techniques to acquire and process multimodal data over a sequence of frames. The system architecture integrates configurable software components, cloud-based processing, and a user-facing mobile application to facilitate acquisition, point cloud registration, 3D mesh reconstruction, and/or cross-sectional perimeter analysis for precise body measurement.

In some embodiments, and with reference to FIGS. 1–6, the present disclosure provides a comprehensive system and method for registration and 3D reconstruction from point clouds obtained using a depth-sensing camera, such as a TrueDepth camera that captures synchronized depth and RGB image data. As shown in FIG. 3, an electronic device 300 captures RGB and depth data using a camera 310 and one or more pose sensors 320. The primary purpose of the system is to process these multimodal inputs, collected over a sequence of frames, to generate a consolidated point cloud, reconstruct a 3D mesh of a human figure, and perform perimeter analysis on horizontal cross-sections of the resulting mesh. The system relies on several established algorithms and computational techniques, including point cloud registration, computer vision-based feature matching, volumetric reconstruction, and mesh analysis, as shown in the processing flowchart of FIG. 5.

The pipeline may implement a configuration phase in which an argument parser (e.g., software module not shown) is used to define input parameters. These parameters may include the preferred point cloud registration method, options for generating and exporting mesh files in standard formats such as PLY, visualization settings, and flags for enabling mesh segmentation or measurement processing. The configuration also initializes the capture mode and storage protocol of the device, which interface with the hardware shown in FIG. 3 and system-level architecture of FIG. 4.

In some embodiments, the system proceeds to load RGB image and depth data from input files, typically organized as paired binary files representing each frame of the captured sequence. These image-depth pairs are used to generate raw point clouds. As illustrated in FIG. 1, the system may optionally perform foreground segmentation to isolate the subject of interest, such as a person, using an object detection model. In some embodiments, a deep learning-based object detection and/or segmentation model, including, but not limited to, the YOLOv8 (You Only Look Once, Version 8) deep learning model, is employed to identify and isolate human figures in each RGB frame, which guides the generation of focused, subject-specific point clouds. Segmentation results in a foreground FIG. 215, which is further processed in subsequent steps.

To consolidate multiple point clouds into a coherent 3D representation, the system performs spatial alignment using point cloud registration techniques. One approach uses ICP, an algorithm that minimizes distances between corresponding points in sequential clouds until convergence. ICP can be applied in a sequential manner or with loop closure, where the system attempts to align the first and last point clouds to reduce cumulative registration errors. This alignment may occur within the point cloud registration module referenced in FIG. 5, block 530.

Alternatively, the system may use one or more CV techniques to assist with alignment. In this approach, visual features are extracted from RGB images using the SIFT algorithm, and matching features across adjacent frames are used to estimate camera motion. This visual pose estimation can be used alone or in combination with ICP in a hybrid approach, where feature-based initialization is refined through geometric alignment.

After registration, the system reconstructs the 3D surface using volumetric integration. In some embodiments, it applies a TSDF, a technique that fuses depth data into a voxel grid where each voxel encodes a signed distance to the nearest surface. The surface is extracted from the zero-crossing of the distance function and converted into a triangular mesh using methods such as Marching Cubes. The resulting mesh is saved in a file format such as PLY for visualization and further analysis and is associated with the output step in FIG. 5 and mesh integration shown in FIG. 6.

To ensure the quality of the reconstructed mesh, the system applies post-processing filters to remove noise and outliers. A z-score-based filter may be used to eliminate anomalous vertices whose positions deviate from the local geometry. After cleaning, the mesh undergoes cross-sectional analysis in which it is intersected with a series of horizontal planes at varying heights. As shown in FIG. 6, the system calculates the perimeter of each intersection, enabling accurate body measurement extraction from the 3D representation. In the user-facing application, the display module may allow the user to select slices interactively to view or retrieve body dimensions.

In some embodiments, the reconstructed mesh and extracted measurement data can be compressed into a single archive, such as a ZIP file, for efficient storage and transmission. This may be facilitated through the remote server infrastructure illustrated in FIG. 4, where mesh and measurement data can be transferred from the server 410 back to the electronic device 420.

A range of algorithms supports the functionality of the system and contributes to the generation of accurate three-dimensional body representations from RGB and depth sensor data captured by a consumer electronic device. In particular, ICP registration may be used to align point clouds generated from one or more sequential frames of RGB and depth data. The ICP algorithm operates by iteratively minimizing the Euclidean distance between corresponding points in a first point cloud and a second point cloud. During operation, the processor identifies candidate correspondence pairs between points of the respective point clouds and computes a rigid transformation including one or more rotation and translation parameters that reduce overall alignment error. The processor then applies the computed transformation to the point cloud and repeats the correspondence and transformation estimation steps until a convergence criterion is satisfied. Through repeated iterations, the point clouds become spatially registered and aggregated into a coherent geometric representation of the captured human body.

The use of ICP within the system provides a technical improvement in the reconstruction of 3D meshes from sequential sensor data captured by a mobile device. Consumer-grade depth sensors often produce incomplete or partially overlapping point clouds due to limitations in sensor field-of-view, occlusions caused by body posture, and/or user movement during scanning. Without point cloud registration techniques, these partial point clouds remain misaligned and cannot be reliably combined into a single coherent representation of the body geometry. By performing iterative geometric alignment, the ICP algorithm fuses multiple partial observations into a consistent spatial model, thereby improving the accuracy of the reconstructed mesh and reducing geometric artifacts that could otherwise degrade measurement extraction and garment alignment operations.

In some embodiments, ICP registration may be supplemented by feature-based matching algorithms, such as the scale-invariant feature transform SIFT to provide an initial estimate of relative scale and orientation between point clouds prior to performing the geometric refinement stage of ICP. The processor may identify visual features from RGB images corresponding to each depth frame and compute feature vectors that remain stable across changes in viewpoint or scale. Matching feature vectors between frames produces an initial transformation estimate that accelerates convergence of the ICP algorithm and improves registration when point clouds contain noise, sparse depth samples, or partial occlusions.

Additionally, volumetric reconstruction algorithms may operate in conjunction with the registered point clouds to generate a continuous surface representation of the body. For example, a truncated signed distance function TSDF may integrate depth measurements from multiple aligned point clouds into a voxel grid in which each voxel stores a signed distance value relative to the nearest surface. Surface extraction algorithms, such as marching cubes, may convert the volumetric representation into a triangular mesh suitable for visualization, measurement extraction, and garment alignment. Post-processing algorithms, including connected triangle clustering, may remove disconnected components or noise artifacts that arise from sensor error, background interference, or incomplete depth capture.

These algorithmic techniques address the technical problem of reconstructing accurate 3D human body models using data captured by portable devices with limited sensing capability. The described processing pipeline improves the operation of the computing device by allowing reliable fusion of RGB and depth data, improving the stability of 3D mesh generation, and supporting real-time garment alignment and simulation within a virtual fitting pipeline. These improvements allow complex geometric reconstruction tasks to occur on widely available mobile computing platforms that traditionally lack specialized scanning hardware, while maintaining sufficient geometric precision for body measurement extraction and garment fit analysis.

The SIFT algorithm may provide image feature detection and/or one or more feature matching operations that support pose estimation across sequential RGB frames captured during the scanning process. In operation, the processor analyzes one or more of the RGB images to identify one or more distinctive image features, such as an edge, a corner, a ridge, a textured region, and/or a localized contrast pattern that remains detectable across different viewpoints and lighting conditions. For example, the processor may detect a feature point corresponding to a visually distinctive region of the body and/or clothing, such as an edge of a shoulder seam, an outline of a sleeve, a boundary of a neckline, an intersection of a collar and torso, a fold in clothing fabric, and/or a region of contrasting texture, such as a button, a zipper, and/or a patterned fabric region. The processor computes a feature descriptor for each detected feature using local gradient information derived from image intensity values. These descriptors represent structural characteristics of the local image region surrounding each feature and allow the processor to compare features detected in different images.

Once the feature descriptors are generated, the processor performs feature matching by comparing a descriptor extracted from a first RGB frame with a descriptor extracted from a second RGB frame. The processor identifies a feature pair that exhibits a high degree of descriptor similarity, thereby establishing correspondence between image features that represent the same physical location on the human body across multiple captured frames. For example, a feature corresponding to an edge of a shoulder in a first frame may be matched with a corresponding shoulder edge feature detected in a subsequent frame after the user rotates slightly. Similarly, a feature corresponding to a waistline, an elbow region, and/or a distinctive fabric pattern may be matched between frames. Because the SIFT algorithm normalizes feature descriptors relative to image scale and orientation, the feature matching process remains accurate even when the user rotates during scanning, when a distance between the user and the camera changes slightly, and/or when the body portion captured in the frame shifts within a field of view. As a result, pose estimation derived from these feature correspondences remains substantially invariant to scale changes and rotational differences between frames.

Using the matched feature pairs, the processor calculates one or more geometric transformations that describe a relative pose between the first frame and the second frame. These transformations may include rotation, translation, and/or scale parameters that represent a change in camera perspective and/or body orientation between successive image captures. For example, if the user rotates slightly to the left between frames, the processor may estimate a corresponding rotational transformation that accounts for the change in viewpoint. If the user steps slightly closer to the device during scanning, the processor may estimate a scale adjustment corresponding to the change in perceived body size within the image frame. The calculated transformation parameters may then be used to initialize and/or refine point cloud alignment processes, such as the iterative closest point algorithm ICP, which aligns the point clouds generated from corresponding depth frames.

The incorporation of SIFT-based feature detection and matching addresses technical challenges associated with reconstructing a stable 3D representation of a human body using image data captured from a mobile device. In particular, handheld scanning scenarios frequently involve slight variations in user position, body posture, and/or camera orientation between frames. For example, a user may rotate while standing in place, shift weight from one leg to another, raise and/or lower an arm, and/or slightly change posture during a capture sequence. Traditional geometric alignment approaches relying solely on depth data may fail when depth measurements contain noise, sparse sampling, and/or partial occlusions caused by clothing folds and/or body posture. The SIFT feature detection and matching process introduces an additional layer of visual correspondence information derived from RGB images, improving the reliability of pose estimation under these conditions.

This algorithmic approach provides several technical benefits within the context of the described 3D reconstruction pipeline. First, the use of scale- and rotation-invariant feature descriptors improves the frame-to-frame pose estimation, thereby reducing cumulative alignment error during point cloud aggregation. Second, feature-based pose initialization reduces the number of iterations required by geometric alignment algorithms such as ICP, which improves processing efficiency and reduces the computational load on mobile processors. Third, improved pose estimation accuracy contributes to more stable volumetric fusion when constructing a mesh from multiple point clouds, resulting in reduced surface distortion and more accurate body measurements extracted from the reconstructed 3D mesh. Fourth, the additional feature correspondence data helps mitigate errors caused by incomplete depth capture, a reflective clothing surface, and/or a temporary occlusion, which commonly occur when scanning a human body using consumer-grade depth sensors. Thus, these improvements enhance the operation of the computing system by improving the reliability and computational efficiency of image-to-mesh reconstruction processes performed using RGB and depth data captured by consumer electronic devices.

The TSDF volume fusion technique may support reconstruction of a stable three-dimensional representation from depth sensor measurements that contain noise, missing regions, and/or partial observations. In operation, the processor receives depth measurements corresponding to multiple RGB and depth frames captured from different viewpoints during a scanning sequence. Each depth frame is converted into a set of spatial measurements that describe distances from the sensor to surfaces of the observed object, such as a human body. These depth measurements are incorporated into a volumetric representation defined within a three-dimensional voxel grid. Each voxel within the grid stores a signed distance value representing a distance between the voxel location and a nearest observed surface, along with a weighting value that reflects a confidence level of the measurement derived from one or more depth frames.

During the fusion process, the processor integrates depth information from successive frames into the voxel grid by updating the signed distance values of voxels that intersect with the observed depth measurements. For example, when the depth sensor captures a front view of the human body in a first frame and a side view of the body in a second frame, the TSDF integration process combines the measurements from both views within the same volumetric grid. Similarly, a subsequent frame may capture a rear view of the torso, an oblique view of a shoulder region, and/or a view of a leg region previously occluded in earlier frames. The TSDF fusion process integrates these additional observations so that the volumetric grid gradually accumulates information from multiple viewpoints. As additional frames are incorporated, the processor updates voxel values using weighted averaging of the observed distances so that noise and outliers from individual frames are attenuated. This integration process allows the reconstructed surface to remain stable even when the depth sensor produces noisy measurements caused by reflective clothing material, a fold in fabric, a shadowed body region, and/or partial occlusion from an arm or a garment layer.

The volumetric grid generated through TSDF integration may then be converted into a geometric surface representation suitable for visualization and analysis. For example, the processor may apply a surface extraction algorithm, such as marching cubes, to identify locations where the signed distance values transition through zero within the voxel grid. These zero-crossing locations correspond to an estimated surface of the observed object and may be used to construct a triangular mesh representing the reconstructed body geometry. The resulting mesh may then be used for subsequent operations, such as anatomical landmark detection, body measurement extraction, garment alignment, garment deformation modeling, and/or virtual fitting simulation. For example, a waistline measurement may be derived from a cross-sectional slice of the reconstructed mesh, a shoulder landmark may be detected from a curvature region of the mesh, and/or a garment model may be aligned to the mesh using corresponding anatomical attachment points.

The use of TSDF-based volumetric fusion addresses technical challenges associated with reconstructing a continuous three-dimensional surface from depth sensors integrated into consumer electronic devices. Depth sensors commonly generate measurements that contain noise, incomplete surface observations, and depth discontinuities caused by reflective surfaces, clothing folds, and/or occlusion from body posture. For example, a depth sensor may fail to capture a complete surface of a torso when a user's arm partially blocks the sensor view, when a loose garment creates folds that scatter depth measurements, and/or when lighting conditions produce irregular sensor reflections. Without volumetric fusion techniques, individual depth frames would produce fragmented point clouds that are insufficient for generating stable meshes suitable for measurement extraction and garment fitting analysis. By integrating depth measurements from multiple viewpoints into a unified voxel-based representation, TSDF fusion reduces measurement noise, fills gaps between partial observations, and stabilizes the surface geometry reconstructed from the captured sensor data.

This reconstruction technique provides several technical benefits within the described system. First, weighted integration of multiple depth observations improves the geometric accuracy of the reconstructed mesh relative to reconstructions generated from a single frame. Second, the volumetric representation reduces the influence of sensor noise by averaging measurements from multiple frames, which improves the stability of downstream algorithms, such as landmark detection, skeletal pose estimation, garment alignment, and garment deformation modeling. Third, the voxel-based representation supports incremental updates as additional frames are captured, which allows the reconstruction process to occur progressively during scanning with a handheld device. Fourth, the resulting continuous mesh improves the reliability of cross-sectional measurement calculations performed on the reconstructed body geometry, including measurement extraction at a chest region, a waist region, a hip region, and/or a thigh region. Fifth, the consistent volumetric representation improves alignment between reconstructed body meshes and garment meshes, which improves the accuracy of virtual fitting simulations and garment deformation calculations. Thus, the use of TSDF volume fusion improves the operation of the computing system performing 3D reconstruction by producing a stable and geometrically consistent representation of a scanned body using sensor data captured by a mobile device.

A deep learning-based object detection and/or segmentation model may be used to isolate and extract a target object, such as a human body, from each captured RGB frame. The processor applies the segmentation model to the RGB image to generate a pixel-level classification map in which individual pixels are assigned to one or more classes, including a foreground class corresponding to the human body and a background class corresponding to non-body regions of the scene. Based on this classification map, the processor generates a segmentation mask that identifies a set of pixels belonging to the detected human body while excluding pixels associated with surrounding objects, environmental background features, and/or sensor noise. For example, the segmentation model may distinguish a body region from a wall, a floor, furniture, clothing artifacts, and/or other persons that may appear in the field of view. The resulting segmentation mask may then be applied to the RGB image and the corresponding depth data so that only pixels associated with the detected body region are used for subsequent point cloud generation.

The segmentation process improves the accuracy of the 3D reconstruction pipeline by restricting the transformation of image data into point clouds to pixels that correspond to the detected body region. In operation, depth values mapped to background pixels are excluded from the reconstruction process, which reduces geometric noise introduced by surrounding environmental structures and improves the fidelity of the reconstructed point cloud. For example, if a background wall, chair, or other object appears within the camera frame, the segmentation mask prevents those structures from being incorporated into the generated point cloud. This filtering operation improves the reliability of downstream algorithms that rely on geometric consistency between frames, including point cloud alignment, mesh generation, and anatomical landmark detection.

In addition, the segmentation model improves the operation of the computing system by reducing computational overhead during subsequent processing stages. Because only the segmented body pixels are processed during point cloud generation, the processor performs fewer geometric transformations when converting image pixels and associated depth values into 3D spatial coordinates. This reduction in processed data volume improves processing efficiency on mobile computing devices that possess limited processing resources and memory capacity. The segmentation mask may also support the generation of an outer perimeter edge representing a boundary of the detected body region, which further assists in measurement extraction and cross-sectional analysis of the reconstructed mesh.

The segmentation model may further improve temporal stability during multi-frame scanning. When a user rotates and/or changes posture during the capture sequence, the segmentation process consistently identifies the body region across frames despite variations in lighting conditions, clothing texture, and/or camera viewpoint. This stable body region identification improves the reliability of feature detection, point cloud aggregation, and pose estimation performed during the reconstruction pipeline. For example, the segmentation mask prevents non-body features such as a moving background object or a textured wall pattern from being interpreted as part of the body geometry during feature matching or point cloud registration.

Thus, the use of a deep learning-based object detection and/or segmentation model introduces a structured image preprocessing stage that improves the functioning of the computing system performing 3D reconstruction. By isolating the body region prior to point cloud generation, the system improves geometric accuracy of the reconstructed mesh, reduces computational complexity during point cloud processing, and increases the reliability of pose estimation and mesh alignment algorithms operating on the captured sensor data. These improvements provide enhanced stability and accuracy within the 3D reconstruction pipeline implemented on mobile computing devices that capture RGB and depth data during a virtual fitting workflow.

A deep learning-based object detection and/or segmentation model refers to a machine learning model implemented using one or more neural network architectures that are trained to analyze image data and identify objects within the image. Such models typically learn hierarchical visual features from training datasets through multi-layer neural network structures, such as convolutional neural networks. During operation, the model processes an input image and produces one or more outputs that indicate the presence, location, and/or pixel-level boundaries of detected objects within the image. In some implementations, the model may generate bounding boxes representing approximate object locations, while in other implementations the model may generate a segmentation mask in which individual pixels are classified as belonging to a detected object class or to a background class.

In the context of the described system, the deep learning-based object detection and/or segmentation model analyzes RGB image frames captured by an image sensor and identifies pixels corresponding to a target object, such as a human body. The model may output a classification map or segmentation mask that isolates the body region from surrounding environmental features, including walls, furniture, floors, and other objects within the camera's field of view. This pixel-level identification allows the processor to extract only the image pixels and corresponding depth data that represent the detected body region prior to generating point clouds and reconstructing a three-dimensional mesh.

Examples of deep learning-based object detection and/or segmentation models include neural network architectures designed for object localization and pixel-level segmentation tasks. For example, such models may include a You Only Look Once model, such as a YOLO-family model including YOLOv5, YOLOv7, or YOLOv8; a region-based convolutional neural network model such as Faster R-CNN or Mask R-CNN; a segmentation network such as U-Net; a transformer-based detection architecture such as DETR; and/or other neural network architectures trained to perform object detection and/or semantic or instance segmentation. These models may operate using trained weight parameters derived from datasets containing labeled examples of human bodies and other objects, thereby allowing the model to reliably distinguish the target body region from surrounding background content during image processing.

The use of such models within the described reconstruction pipeline improves the reliability of body isolation during preprocessing of the captured image frames. By automatically detecting and segmenting the body region prior to point cloud generation, the system reduces the likelihood that one or more background structures and/or environmental noise will be incorporated into the generated 3D representation. This improves the accuracy of subsequent geometric reconstruction operations and supports more reliable mesh generation, body measurement extraction, and/or garment alignment during a virtual fitting simulation.

Connected triangle clustering may be applied to the reconstructed mesh to identify and isolate coherent geometric structures within the triangular surface representation. After the three-dimensional mesh is generated from the aggregated point clouds, the mesh may contain one or more disconnected components that originate from sensor noise, incomplete depth measurements, and/or background structures inadvertently incorporated during the reconstruction process. For example, small mesh fragments may correspond to environmental surfaces such as a floor region, a wall region, a chair edge, and/or transient sensor artifacts that appear as isolated triangle groups. The processor may therefore perform a connectivity analysis across the triangular faces of the mesh to identify clusters of triangles that share common vertices and edges.

During this process, the processor analyzes adjacency relationships between triangles within the mesh to determine which triangles belong to a connected surface region. Triangles that share one or more edges with neighboring triangles may be grouped into a connected component. The processor then evaluates one or more geometric attributes of each connected component, such as a number of triangles within the component, a total surface area represented by the component, and/or a spatial extent of the component within the three-dimensional coordinate space. For example, a connected component representing a torso and limb structure may contain thousands of triangles and span a large portion of the reconstructed mesh volume, while a noise artifact corresponding to a reflective object in the background may contain only a small set of disconnected triangles.

Based on this analysis, the processor may classify connected components according to their relative size and structural coherence. Smaller components that fall below a threshold triangle count and/or surface area threshold may be identified as noise artifacts or irrelevant structures. These components may be removed from the mesh, while the largest connected component and/or one or more major components are retained as the primary representation of the scanned subject. In many cases, the largest connected component corresponds to the reconstructed human body because it contains the majority of the triangles generated from the depth measurements associated with the foreground body region.

The use of connected triangle clustering addresses technical challenges associated with reconstructing a continuous surface representation from noisy depth sensor data. Depth sensors integrated into consumer electronic devices frequently capture extraneous surfaces within the scanning environment, particularly when the user performs a body scan in a room containing surrounding objects and surfaces. Without filtering operations, these extraneous surfaces may remain embedded within the reconstructed mesh, which can degrade the accuracy of downstream processes such as anatomical landmark detection, body measurement extraction, and garment alignment.

Applying connected triangle clustering improves the operation of the reconstruction pipeline by isolating the principal geometric structure associated with the scanned body while eliminating extraneous mesh fragments that could interfere with further analysis. For example, removal of disconnected triangle clusters prevents background surfaces from influencing measurement calculations when performing cross-sectional slicing of the mesh at locations such as a chest region, a waist region, and/or a hip region. Similarly, elimination of small mesh fragments improves the stability of garment alignment operations because attachment points of a garment model are aligned only with the primary body mesh rather than with spurious geometric artifacts.

This clustering process therefore improves the reliability of the mesh representation used by the computing system and reduces computational overhead during subsequent processing stages. By reducing the number of mesh components and eliminating irrelevant triangle groups, the processor performs fewer geometric comparisons during landmark detection, collision detection, and garment deformation simulation. Thus, connected triangle clustering improves the functioning of the computing system performing three-dimensional reconstruction by producing a cleaner and more structurally coherent mesh representation derived from sensor-generated point cloud data.

This algorithmic framework facilitates the generation of accurate 3D models of the human body from commodity RGB-D sensor data and provides the necessary structure for supporting applications such as virtual garment fitting, body measurement, and pose analysis. As shown in FIG. 2, once the mesh has been generated and segmented into a foreground FIG. 215, a 3D model of a garment 220 may be aligned and overlaid onto the mesh to simulate a virtual fitting environment. The overlaid garment conforms to the shape and pose of the reconstructed body, completing the end-to-end visualization of the virtual try-on process.

### EXAMPLE 2

This example describes some embodiments of the system to perform 3D body reconstruction and measurement using a mobile device equipped with a depth-sensing camera. In this example, embodiments, various components, including a mobile application, onboard sensors, and remote server infrastructure, cooperate to capture, process, and visualize high-accuracy body meshes in a self-operated, user-friendly environment.

With reference to FIGS. 3–5, the system may provide a mobile-enabled platform for 3D body reconstruction and measurement using a depth-sensing camera integrated into a consumer smartphone device, such as the TrueDepth camera found in recent iPhone models. As illustrated in FIG. 3, the electronic device 300 includes a camera 310 and one or more pose sensors 320 that may capture RGB images and depth data of at least one portion of a human body. This configuration enables the generation of body meshes with sub-centimeter accuracy and allows for precise measurement extraction.

The system architecture includes a mobile application, a remote server, and an API, as shown in the networked configuration of FIG. 4. The mobile application initiates the capture process and transmits data to the server for processing. For example, the mobile application may acquire a sequence of synchronized RGB and depth frames using an imaging device of the electronic device while the user rotates in place within a field of view of the camera. During operation, the application activates both the RGB image sensor and one or more depth-sensing components to capture color image data and corresponding depth measurements at successive time intervals. Each captured frame therefore contains both visual information describing the appearance of the user and depth information describing the distance between the imaging device and surfaces of the user’s body. As the user gradually rotates, different portions of the body become visible to the camera, allowing the system to observe the body surface from multiple viewpoints. For example, a capture sequence may initially record a front view of the torso, followed by partial side views of the shoulders and arms, and subsequently rear views of the back and hip regions as the rotation continues. The processor stores these sequential frames and associates them with corresponding timestamps and pose sensor readings, which assist in estimating the relative spatial relationships between the captured frames.

The rotational capture process may be guided by instructions presented within the mobile application interface to assist the user in maintaining an appropriate scanning motion. For example, the application may display visual prompts that instruct the user to rotate slowly in place while maintaining a fixed distance from the camera. In some embodiments, the application may display a silhouette outline, alignment indicator, and/or positional guide to help the user remain centered within the capture region. The application may also monitor the captured frames to determine whether sufficient surface coverage has been obtained across different viewing angles. If portions of the body surface remain unobserved, the application may prompt the user to continue rotating until additional views of the body are captured. This guided capture process allows the system to obtain a complete set of observations corresponding to a full rotation of the subject without requiring specialized scanning equipment.

As the sequence of RGB and depth frames is captured, the processor converts depth measurements associated with foreground pixels into spatial coordinates to generate point clouds corresponding to each captured viewpoint. These point clouds represent partial observations of the body surface from different angles around the user. Because the user rotates while the camera remains stationary relative to the device, each captured frame provides a slightly different perspective of the body geometry. The processor aligns these partial point clouds using frame-to-frame registration techniques so that the observed surface segments may be aggregated into a unified spatial representation. For example, point cloud data corresponding to a front view of the torso may be aligned with data corresponding to a side view of the torso, allowing the processor to reconstruct the curved surface of the body across multiple viewpoints.

This rotational acquisition method addresses practical limitations associated with scanning systems that require camera movement around a subject. Traditional three-dimensional scanning approaches often rely on multiple cameras positioned around the subject or on mechanical systems that move a camera along a circular path. Such systems may require specialized hardware setups and controlled environments. In contrast, the described approach allows a single consumer electronic device to capture sufficient data for three-dimensional reconstruction while the user rotates in place. Because the device remains stationary relative to the user during capture, the system reduces the complexity associated with tracking camera movement and simplifies the capture workflow for self-operated scanning scenarios.

The rotational scanning method also provides technical benefits for the reconstruction pipeline. Capturing views of the body from multiple orientations improves the completeness of the resulting point cloud by reducing regions that would otherwise remain occluded when observed from a single viewpoint. For example, portions of the body surface, such as the back, shoulder blades, and side contours, may not be visible in a front-facing capture but become observable as the user rotates. Aggregating these observations allows the processor to construct a more complete three-dimensional representation of the subject. In addition, maintaining a stationary camera position relative to the device simplifies sensor calibration and improves consistency between sequential frames, which improves the stability of point cloud alignment and mesh reconstruction processes. Accordingly, the rotational capture workflow improves the ability of the computing system to generate accurate three-dimensional models of the human body using RGB and depth data captured by a mobile device.

Captured data is transmitted via the API to a server 410, where point cloud registration and 3D mesh reconstruction are performed, as shown in FIG. 5. The resulting body mesh may then be returned to the electronic device 420, where measurement extraction and visualization modules allow the user to interact with and analyze the scan results. This approach supports full-body coverage in a constrained environment and enhances usability for consumer-facing virtual fitting, fitness tracking, and/or personalized apparel sizing applications.

### EXAMPLE 3

This example description illustrates some embodiments of a mobile-enabled system architecture for 3D body scanning and measurement, as shown in FIGS. 3–6. In these embodiments, the system integrates a depth-sensing camera-equipped electronic device with a remote server via an API to perform 3D reconstruction and measurement extraction. The description outlines how various components, including the on-device camera and sensors, a mobile application, and a cloud-based processing pipeline, cooperate to capture, process, and return accurate body meshes and measurement data. The system includes the hardware configuration (FIG. 3), network communication framework (FIG. 4), reconstruction pipeline (FIG. 5), and interactive measurement interface (FIG. 6), thereby providing a comprehensive example of a self-operated, consumer-facing 3D scanning platform.

In some embodiments, and with reference to FIGS. 3–6, the system includes a mobile-enabled 3D scanning platform integrated with a remote server through an API for performing 3D reconstruction and body measurement extraction. As shown in FIG. 3, the electronic device 300 includes a camera 310, such as a front-facing depth and/or a RGB camera, and one or more pose sensors 320 that may capture synchronized RGB and depth data of a human subject. A processor 330, coupled to a memory 336, may transmit this scan data to a remote processing system.

The system architecture is illustrated in FIG. 4, where the electronic device 420 communicates with a server 410 via, including but not limited to, an HTTP-based API and/or a websocket connection. The API receives the RGB and depth data captured by the mobile application, executes a 3D reconstruction pipeline, and returns both a 3D mesh and associated measurement data. The reconstruction process may include point cloud alignment using vision-based ICP registration, followed by volumetric fusion using a TSDF, as described in the method steps of FIG. 5.

Once the reconstruction is complete, the server returns a 3D object and associated perimeter measurements to the mobile device. The 3D object is rendered within the mobile application, where the user can view the reconstructed body mesh and interact with a measurement interface. As illustrated in FIG. 6, the mobile application allows the user to adjust a slider or interactive control to select specific heights along the vertical axis of the mesh. At each selected position, the system calculates and displays the perimeter of the corresponding cross-section, enabling precise measurement at locations such as the waist, chest, or hips.

In some embodiments, the 3D object files transmitted from the server to the device are structured to support mobile rendering and user interaction while maintaining accurate measurement data. The user-facing application supports dynamic updates to the visualization and measurement plane as the slider is adjusted.

Testing has demonstrated that an optimal capture distance for scanning is approximately 16 inches from the camera to the subject. The system supports full-body coverage by having the user rotate in place during capture, eliminating the need for camera movement or external scanning hardware. Additional testing is being conducted to evaluate and extend the operational range for broader conditions and user environments.

This embodiment illustrates a system architecture in which the mobile application and remote server cooperate to enable 3D scanning, reconstruction, and measurement from a depth camera-equipped device. The integration of the components shown in FIG. 3, network communication pathways of FIG. 4, reconstruction processes in FIG. 5, and interactive measurement tools in FIG. 6 enables users to obtain body dimension data directly from a handheld device in a self-operated workflow.

### EXAMPLES

Embodiment 1. A method comprising: capturing, at an image sensor of an electronic device, at least one red, green, blue (RGB) image of at least one portion of a human body; capturing, at one or more depth sensors of the electronic device, depth data indicating an estimated distance of the at least one portion of the human body from the image sensor; segmenting, at a processor of the electronic device, the at least one RGB image into foreground pixels and background pixels, based on the depth data, wherein the foreground pixels correspond to a human body representation; transforming, at the processor, the foreground pixels corresponding to the human body representation and the depth data mapped to each of the foreground pixels, into one or more three-dimensional (3D) point clouds corresponding to the at least one portion of the human body, based at least in part on one or more intrinsic parameters of the image sensor; estimating a 3D mesh of the human body, the estimating comprising aggregating, at the processor, the one or more 3D point clouds of the human body representation; extracting, at the processor, one or more measurement values from the 3D mesh of the human body representation; and aligning, at the processor, the 3D mesh of the human body representation with a 3D model of a garment configured for a virtual fitting, based on the one or more measurement values from the 3D mesh of the human body representation.

Embodiment 2. The method of embodiment 1, further comprising: generating a binary mask of at least the portion of the human body representation, the generating comprising distinguishing, at the processor, an outer perimeter edge of at least the portion of the human body from the foreground pixels of the image.

Embodiment 3. The method of embodiment 1, further comprising: generating, based on the depth data, filtered depth data; identifying the at least one portion of the human body within the at least one RGB image by the processor based on the filtered depth data, wherein generating the 3D mesh of the human body representation comprises: estimating, at the processor, one or more points on the at least one RGB image corresponding to a first mesh portion; and aligning, at the processor, the one or more estimated points of the first mesh portion with one or more estimated points of a second mesh portion.

Embodiment 4. The method of embodiment 1, further comprising: intercepting a plane of the 3D mesh of the human body representation to generate a horizontal slice by the processor to calculate a measurement value of the one or more measurement values of a body dimension of the 3D mesh of the human body representation.

Embodiment 5. The method of embodiment 1, wherein the 3D model of the garment at least partially conforms to surface geometry of the mesh.

Embodiment 6. The method of embodiment 1, further comprising: limiting the one or more intrinsic parameters of the image sensor to at least one of: a focal length, a central point coordinate, and a distortion coefficient.

Embodiment 7. The method of embodiment 1, further comprising: aligning, by the processor, a first point cloud of the one or more point clouds with a second point cloud of the one or more point clouds by minimizing a distance between the first point cloud of the one or more point clouds and the second point cloud of the one or more point clouds, using an iterative closest point (ICP) function.

Embodiment 8. The method of embodiment 1, further comprising: identifying, by the processor, one or more vectors of a first point cloud of the one or more point clouds and one or more vectors of a second point cloud of the one or more point clouds; matching, by the processor, the one or more vectors from the first point cloud with the one or more vectors from the second point cloud to generate one or more matched vectors; and estimating, by the processor, one or more scale and rotation changes between the first point cloud and the second point cloud based on the matched vectors.

Embodiment 9. The method of embodiment 1, further comprising: in response to estimating the 3D mesh of the human body representation, generating a volume from the one or more point clouds at the processor using a truncated signal distance function (TSDF).

Embodiment 10. The method of embodiment 1, wherein the aggregating is implemented by a connected triangle clustering algorithm to generate the 3D mesh of the human body representation to remove one or more disconnected components.

Embodiment 11. An electronic device, comprising: an image sensor configured to capture one or more red, green, blue (RGB) images of at least one portion of a human body; one or more pose sensors configured to capture depth data to indicate an estimated distance of the at least one portion of the human body from the image sensor; and a processor communicatively coupled to the one or more pose sensors and a memory, wherein the memory is configured to store computer readable instructions, that when executed by the processor, cause the processor to: segment a first image of at least the portion of the human body captured at the image sensor of the electronic device into an outer perimeter edge of at least the portion of the human body and background pixels based on the estimated distance of at least the portion of the human body from the image sensor; estimate a first pose of the first image of a skeletal system corresponding to at least the portion of the human body based on the first image and the depth data during a first time period; estimate a second pose of the first image of the skeletal system of at least the portion of the human body based on a second image captured during a second time period and the depth data captured from the one or more pose sensors during the second time period; aggregate a point cloud from the first image and the second image to generate a three-dimensional (3D) mesh of at least the portion of the human body based at least in part on the first pose of at least the portion of the human body and the second pose of at least the portion of the human body; identify, at the processor, one or more body landmarks on the 3D mesh of the at least the portion of the human body; and correspond, at the processor, a 3D model of a garment configured for a virtual fitting, with the 3D mesh of the at least the portion of the human body using the one or more identified body landmarks.

Embodiment 12. The electronic device of embodiment 11, wherein the processor is further configured to: render a black mask over a set of pixels within the outer perimeter edge of at least the portion of the human body, based on the depth data, to occlude at least the portion of the human body of the first image.

Embodiment 13. The electronic device of embodiment 11, wherein the processor is further configured to: render a recommended 3D model of the garment to align with the 3D mesh of the at least the portion of the human body partially based on a global positioning system (GPS) location of the electronic device.

Embodiment 14. The electronic device of embodiment 11, wherein the processor is further configured to: render a recommended 3D model of a garment to align with the 3D mesh of the at least the portion of the human body based at least in part on an age, a race, or a gender of the human body.

Embodiment 15. The electronic device of embodiment 11, wherein the processor is further configured to: adjust the 3D model of the garment using a deformation model to match a shape and the pose data of the 3D mesh of the at least the portion of the human body based on at least one of the identified body landmarks, the point cloud data, and skeletal pose estimations.

Embodiment 16. The electronic device of embodiment 11, wherein the processor is further configured to: track the skeletal system to estimate one or more parts of the body using the depth data and one or more pose estimation algorithms, based at least in part on the first pose, the second pose, and the point cloud data.

Embodiment 17. The electronic device of embodiment 16, wherein the processor is further configured to: extract one or more skeletal points from the 3D mesh of the at least the portion of the human body; align the 3D model of the garment at the one or more extracted skeletal points to match one or more corresponding regions from the 3D mesh of the at least the portion of the human body; scale the 3D model of the garment to fit one or more dimensions of the 3D mesh of the at least the portion of the human body based on one or more calculated body measurements; and render, at a display of the electronic device, the virtual fitting of the 3D model of the garment corresponding with the 3D mesh of the at least the portion of the human body.

Embodiment 18. The electronic device of embodiment 16, wherein the processor is further configured to: perform an iterative closest point (ICP) alignment between the D model of the garment and the 3D mesh of the at least the portion of the human body; detect one or more areas of a collision or an intersection between the 3D model of the garment and the 3D mesh; adjust the fit of the 3D model of the garment based on the detected areas of the collision or the intersection; and apply physics-based simulation of one or more fabric properties to the 3D model of the garment to simulate garment behavior and dispose the 3D model of the garment over the 3D mesh.

Embodiment 19. The electronic device of embodiment 16, wherein the processor is further configured to: adjust the 3D model of the garment in response to body movement and changes in pose detected from real-time depth sensor data; and update an alignment of the 3D model of the garment based on one or more detected changes in posture based on one or more motion vectors of the one or more skeletal points.

Embodiment 20. A system, comprising: a server; and an electronic device communicatively coupled to the server, the electronic device comprising: an image sensor configured to capture one or more RGB images of at least one portion of a human body; one or more pose sensors configured to receive depth data to indicate an estimated distance of the at least the portion of the human body from the image sensor; and a processor communicatively coupled to the one or more pose sensors, the image sensor, and a memory, wherein the memory is configured to store computer readable instructions that, when executed by the processor, cause the processor to: segment a first image of the at least the portion of the human body captured at the image sensor of the electronic device into an outer perimeter outline of the at least the portion of the human body and background pixels based on the depth data; estimate a first pose of the first image of a skeletal system of at least the portion of the human body based on the first image and the depth data during a first time period; estimate a second pose of the first image of the skeletal system of at least the portion of the human body based on a second image captured during a second time period and the depth data captured from the one or more pose sensors during the second time period; aggregate a point cloud from the first image and the second image to generate a mesh of at least the portion of the human body based at least in part on the first pose of at least the portion of the human body and the second pose of at least the portion of the human body; align a first point of the mesh with a first point of a 3D model of a garment configured for a virtual fitting; and transmit data representing the first pose, the second pose, the point cloud, or the mesh to the server for further processing or storage.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “image” may include, and is contemplated to include, a plurality of images. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by ( + ) or ( - ) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
capturing, at an image sensor of an electronic device, at least one red, green, blue (RGB) image of at least one portion of a human body;
capturing, at one or more depth sensors of the electronic device, depth data indicating an estimated distance of the at least one portion of the human body from the image sensor;
segmenting, at a processor of the electronic device, the at least one RGB image into foreground pixels and background pixels, based on the depth data,
wherein the foreground pixels correspond to a human body representation;
transforming, at the processor, the foreground pixels corresponding to the human body representation and the depth data mapped to each of the foreground pixels, into one or more three-dimensional (3D) point clouds corresponding to the at least one portion of the human body, based at least in part on one or more intrinsic parameters of the image sensor;
estimating a 3D mesh of the human body, the estimating comprising aggregating, at the processor, the one or more 3D point clouds of the human body representation;
extracting, at the processor, one or more measurement values from the 3D mesh of the human body representation; and
aligning, at the processor, the 3D mesh of the human body representation with a 3D model of a garment configured for a virtual fitting, based on the one or more measurement values from the 3D mesh of the human body representation.

2. The method of claim 1, further comprising:
generating a binary mask of at least the portion of the human body representation, the generating comprising distinguishing, at the processor, an outer perimeter edge of at least the portion of the human body from the foreground pixels of the image.

3. The method of claim 1, further comprising:
generating, based on the depth data, filtered depth data;
identifying the at least one portion of the human body within the at least one RGB image by the processor based on the filtered depth data,
wherein generating the 3D mesh of the human body representation comprises:
estimating, at the processor, one or more points on the at least one RGB image corresponding to a first mesh portion; and
aligning, at the processor, the one or more estimated points of the first mesh portion with one or more estimated points of a second mesh portion.

4. The method of claim 1, further comprising:
intercepting a plane of the 3D mesh of the human body representation to generate a horizontal slice by the processor to calculate a measurement value of the one or more measurement values of a body dimension of the 3D mesh of the human body representation.

5. The method of claim 1, wherein the 3D model of the garment at least partially conforms to a surface geometry of the mesh.

6. The method of claim 1, further comprising:
limiting the one or more intrinsic parameters of the image sensor to at least one of: a focal length, a central point coordinate, and a distortion coefficient.

7. The method of claim 1, further comprising:
aligning, by the processor, a first point cloud of the one or more point clouds with a second point cloud of the one or more point clouds by minimizing a distance between the first point cloud of the one or more point clouds and the second point cloud of the one or more point clouds, using an iterative closest point (ICP) function.

8. The method of claim 1, further comprising:
identifying, by the processor, one or more vectors of a first point cloud of the one or more point clouds and one or more vectors of a second point cloud of the one or more point clouds;
matching, by the processor, the one or more vectors from the first point cloud with the one or more vectors from the second point cloud to generate one or more matched vectors; and
estimating, by the processor, one or more scale and rotation changes between the first point cloud and the second point cloud based on the matched vectors.

9. The method of claim 1, further comprising:
in response to estimating the 3D mesh of the human body representation, generating a volume from the one or more point clouds at the processor using a truncated signal distance function (TSDF).

10. The method of claim 1, wherein the aggregating is implemented by a connected triangle clustering algorithm to generate the 3D mesh of the human body representation to remove one or more disconnected components.

11. An electronic device, comprising:
an image sensor configured to capture one or more red, green, blue (RGB) images of at least one portion of a human body;
one or more pose sensors configured to capture depth data to indicate an estimated distance of the at least one portion of the human body from the image sensor; and
a processor communicatively coupled to the one or more pose sensors and a memory, wherein the memory is configured to store computer readable instructions, that when executed by the processor, cause the processor to:
segment a first image of at least the portion of the human body captured at the image sensor of the electronic device into an outer perimeter edge of at least the portion of the human body and background pixels based on the estimated distance of at least the portion of the human body from the image sensor;
estimate a first pose of the first image of a skeletal system corresponding to at least the portion of the human body based on the first image and the depth data during a first time period;
estimate a second pose of the first image of the skeletal system of at least the portion of the human body based on a second image captured during a second time period and the depth data captured from the one or more pose sensors during the second time period;
aggregate a point cloud from the first image and the second image to generate a three-dimensional (3D) mesh of at least the portion of the human body based at least in part on the first pose of at least the portion of the human body and the second pose of at least the portion of the human body;
identify, at the processor, one or more body landmarks on the 3D mesh of the at least the portion of the human body; and
correspond, at the processor, a 3D model of a garment configured for a virtual fitting, with the 3D mesh of the at least the portion of the human body using the one or more identified body landmarks.

12. The electronic device of claim 11, wherein the processor is further configured to:
render a black mask over a set of pixels within the outer perimeter edge of at least the portion of the human body, based on the depth data, to occlude at least the portion of the human body of the first image.

13. The electronic device of claim 11, wherein the processor is further configured to:
render a recommended 3D model of the garment to align with the 3D mesh of the at least the portion of the human body partially based on a global positioning system (GPS) location of the electronic device.

14. The electronic device of claim 11, wherein the processor is further configured to:
render a recommended 3D model of a garment to align with the 3D mesh of the at least the portion of the human body based at least in part on an age, a race, or a gender of the human body.

15. The electronic device of claim 11, wherein the processor is further configured to:
adjust the 3D model of the garment using a deformation model to match a shape and the pose data of the 3D mesh of the at least the portion of the human body based on at least one of the identified body landmarks, the point cloud data, and skeletal pose estimations.

16. The electronic device of claim 11, wherein the processor is further configured to:
track the skeletal system to estimate one or more parts of the body using the depth data and one or more pose estimation algorithms, based at least in part on the first pose, the second pose, and the point cloud data.

17. The electronic device of claim 16, wherein the processor is further configured to:
extract one or more skeletal points from the 3D mesh of the at least the portion of the human body;
align the 3D model of the garment at the one or more extracted skeletal points to match one or more corresponding regions from the 3D mesh of the at least the portion of the human body;
scale the 3D model of the garment to fit one or more dimensions of the 3D mesh of the at least the portion of the human body based on one or more calculated body measurements; and
render, at a display of the electronic device, the virtual fitting of the 3D model of the garment corresponding with the 3D mesh of the at least the portion of the human body.

18. The electronic device of claim 16, wherein the processor is further configured to:
perform an iterative closest point (ICP) alignment between the 3D model of the garment and the 3D mesh of the at least the portion of the human body;
detect one or more areas of a collision or an intersection between the 3D model of the garment and the 3D mesh;
adjust the fit of the 3D model of the garment based on the detected areas of the collision or the intersection; and
apply physics-based simulation of one or more fabric properties to the 3D model of the garment to simulate garment behavior and dispose the 3D model of the garment over the 3D mesh.

19. The electronic device of claim 16, wherein the processor is further configured to:
adjust the 3D model of the garment in response to body movement and changes in pose detected from real-time depth sensor data; and
update an alignment of the 3D model of the garment based on one or more detected changes in posture based on one or more motion vectors of the one or more skeletal points.

20. A system, comprising:
a server; and
an electronic device communicatively coupled to the server, the electronic device comprising:
an image sensor configured to capture one or more RGB images of at least one portion of a human body;
one or more pose sensors configured to receive depth data to indicate an estimated distance of the at least the portion of the human body from the image sensor; and
a processor communicatively coupled to the one or more pose sensors, the image sensor, and a memory, wherein the memory is configured to store computer readable instructions that, when executed by the processor, cause the processor to:
segment a first image of the at least the portion of the human body captured at the image sensor of the electronic device into an outer perimeter outline of the at least the portion of the human body and background pixels based on the depth data;
estimate a first pose of the first image of a skeletal system of at least the portion of the human body based on the first image and the depth data during a first time period;
estimate a second pose of the first image of the skeletal system of at least the portion of the human body based on a second image captured during a second time period and the depth data captured from the one or more pose sensors during the second time period;
aggregate a point cloud from the first image and the second image to generate a mesh of at least the portion of the human body based at least in part on the first pose of at least the portion of the human body and the second pose of at least the portion of the human body;
align a first point of the mesh with a first point of a 3D model of a garment configured for a virtual fitting; and
transmit data representing the first pose, the second pose, the point cloud, or the mesh to the server for further processing or storage.
